(19) United States
(12) Patent Application Publication
(10) Pub. No.: US 2016/0091667 A1
(43) Pub. Date: Mar. 31, 2016

(54) OPTICAL FIBER GUIDE, OPTICAL WAVEGUIDE SUBSTRATE COMPRISING OPTICAL FIBER GUIDE, OPTICAL INPUT-OUTPUT DEVICE, AND OPTICAL FIBER MOUNTING METHOD

(71) Applicants: FUJITSU LIMITED, Kawasaki-shi (JP); Photonics Electronics Technology Research Association, Tokyo (JP)

(72) Inventors: Motoyuki Nishizawa, Atsugi (JP); Shigeaki Sekiguchi, Zama (JP)

(73) Assignees: FUJITSU LIMITED, Kawasaki-shi (JP); Photonics Electronics Technology Research Association, Tokyo (JP)

(21) Appl. No.: 14/865,363

(22) Filed: Sep. 25, 2015

(30) Foreign Application Priority Data
Sep. 29, 2014 (JP) 2014-198345

(51) Int. Cl. G02B 6/36; G02B 6/30

(52) U.S. Cl. CPC G02B 6/3652; G02B 6/30; G02B 6/3608; G02B 6/3692

(57) ABSTRACT

An optical fiber guide that guides an optical fiber, the optical fiber guide includes a first substrate, and a guide groove that is formed on a main surface of the first substrate, the optical fiber being insertable from one end side of the guide groove, wherein the guide groove includes a positioning unit that forms a distal end portion of the guide groove, the positioning unit having a slide inclined surface that positions the optical fiber by sliding a distal-end inclined surface of the optical fiber in contact therewith.

### CROSS-REFERENCE TO RELATED APPLICATIONS

This application is based upon and claims the benefit of prior Japanese Patent Application No. 2014-198345 filed on Sep. 29, 2014, the entire contents of which are incorporated herein by reference.

### FIELD

An embodiment relates to an optical fiber guide, an optical waveguide substrate including an optical fiber guide, an optical input-output device, and an optical fiber mounting method.

### BACKGROUND

In information equipment having a plurality of nodes in each of which a CPU and a memory are included, such as a server and a router, there has been developed optical interconnection (optical wiring) technology using an optical signal for data transmission between the nodes with an optical fiber as a transmission line.

Also, in order to achieve power saving and high integration of the information equipment, silicon photonics technology has gathered attention in which a fine optical waveguide is formed on a silicon substrate, and optical devices such as an electric conversion device, an optical modulator, and a multiplexer/demultiplexer are integrated on a chip.

Here, in order to achieve highly-efficient optical coupling between the optical waveguide and the optical fiber, an optical input-output end portion of the optical waveguide and a core of the optical fiber are aligned at high accuracy.

For example, a core at an order of several microns is sometimes used for thinning the optical fiber, and in this case, aligning with high accuracy at an order of submicrons is performed in connecting the optical waveguide and the optical fiber.

Examples of a method for mounting the optical fiber include an active mounting method in which light is actually passed through the optical waveguide and the optical fiber, and alignment is performed while monitoring a light intensity, and a passive mounting method in which alignment of the optical fiber is automatically performed by mounting the optical fiber at a predetermined position. When the methods are compared, the passive mounting method is better in view of improving a production throughput.

As the passive mounting of the optical fiber, there is known a mounting method using a V-grooved substrate including V grooves in which a plurality of optical fibers are arranged. For example, it is noted that a technique for positioning and fixing an optical fiber connector in which an optical fiber is arranged in a V groove to a package on which a light emission device or the like is mounted, by using a clamp (see Patent document 1).

[Patent document 1] Japanese Laid-open Patent Publication No. 2006-65358

[Patent document 2] Japanese Laid-open Patent Publication No. 10-223985

[Patent document 3] Japanese Laid-open Patent Publication No. 6-151903

### SUMMARY

According to an aspect of the embodiment, an optical fiber guide that guides an optical fiber, the optical fiber guide includes a first substrate, and a guide groove that is formed on a main surface of the first substrate, the optical fiber being insertable from one end side of the guide groove, wherein the guide groove includes a positioning unit that forms a distal end portion of the guide groove, the positioning unit having a slide inclined surface that positions the optical fiber by sliding a distal-end inclined surface of the optical fiber in contact therewith.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a configuration diagram of an optical communication apparatus according to an embodiment;

FIG. 2 is a sectional view of an optical module according to the embodiment;

FIG. 3 is a view illustrating a groove formation surface of an optical fiber guide according to the embodiment;

FIG. 4 is a sectional view on an arrow A1-A2 illustrated in FIG. 3;

FIG. 5A is a view illustrating a step of manufacturing the optical fiber guide according to the embodiment;

FIG. 5B is a view illustrating a step of manufacturing the optical fiber guide according to the embodiment;

FIG. 5C is a view illustrating a step of manufacturing the optical fiber guide according to the embodiment;

FIG. 5D is a view illustrating a step of manufacturing the optical fiber guide according to the embodiment;

FIG. 5E is a view illustrating a step of manufacturing the optical fiber guide according to the embodiment;

FIG. 5F is a view illustrating a step of manufacturing the optical fiber guide according to the embodiment;

FIG. 5G is a view illustrating a step of manufacturing the optical fiber guide according to the embodiment;

FIG. 5H is a view illustrating a step of manufacturing the optical fiber guide according to the embodiment;

FIG. 5I is a view illustrating a step of manufacturing the optical fiber guide according to the embodiment;

FIG. 5J is a view illustrating a step of manufacturing the optical fiber guide according to the embodiment;

FIG. 5K is a view illustrating a step of manufacturing the optical fiber guide according to the embodiment;

FIG. 5L is a view illustrating a step of manufacturing the optical fiber guide according to the embodiment;

FIG. 5M is a view illustrating a step of manufacturing the optical fiber guide according to the embodiment;

FIG. 5N is a view illustrating a step of manufacturing the optical fiber guide according to the embodiment;

FIG. 5O is a view illustrating a step of manufacturing the optical fiber guide according to the embodiment;

FIG. 5P is a view illustrating a step of manufacturing the optical fiber guide according to the embodiment;

FIG. 5Q is a view illustrating a step of manufacturing the optical fiber guide according to the embodiment;

FIG. 5R is a view illustrating a step of manufacturing the optical fiber guide according to the embodiment;

FIG. 5S is a view illustrating a step of manufacturing the optical fiber guide according to the embodiment;

FIG. 5T is a view illustrating a step of manufacturing the optical fiber guide according to the embodiment;

FIG. 6A is a view illustrating a step of mounting the optical fiber guide according to the embodiment;

FIG. 6B is a view illustrating a step of mounting the optical fiber guide according to the embodiment;

FIG. 7 is a configuration diagram of an optical fiber array according to the embodiment;

FIG. 8A is a view illustrating a step of mounting optical fibers according to the embodiment;

FIG. 8B is a view illustrating a step of mounting the optical fibers according to the embodiment;

FIG. 8C is a view illustrating a step of mounting the optical fibers according to the embodiment;

FIG. 8D is a view illustrating a step of mounting the optical fibers according to the embodiment;

FIG. 9 is a view illustrating an optical fiber alignment jig according to the embodiment;

FIG. 10A is a view for explaining a positioning mechanism for the optical fiber in the optical fiber guide;

FIG. 10B is a view for explaining the positioning mechanism for the optical fiber in the optical fiber guide;

FIG. 10C is a view for explaining the positioning mechanism for the optical fiber in the optical fiber guide;

FIG. 10D is a view for explaining the positioning mechanism for the optical fiber in the optical fiber guide;

FIG. 11A is a view for explaining an optical fiber connector according to a comparative example;

FIG. 11B is a view for explaining the optical fiber connector according to the comparative example;

FIG. 11C is a view for explaining the optical fiber connector according to the comparative example; and

FIG. 11D is a view for explaining the optical fiber connector according to the comparative example.

### DESCRIPTION OF EMBODIMENT

In the conventional V-grooved substrate, little clearance is provided between the V groove that accommodates the optical fiber and the optical fiber due to a need for ensuring alignment accuracy between the optical waveguide and the optical fiber, and thus, it is not possible to say that workability of mounting the optical fiber is good.

### EMBODIMENT

In the following, an embodiment will be described in detail with reference to the drawings.

<<Structure of an Optical Communication Apparatus>>

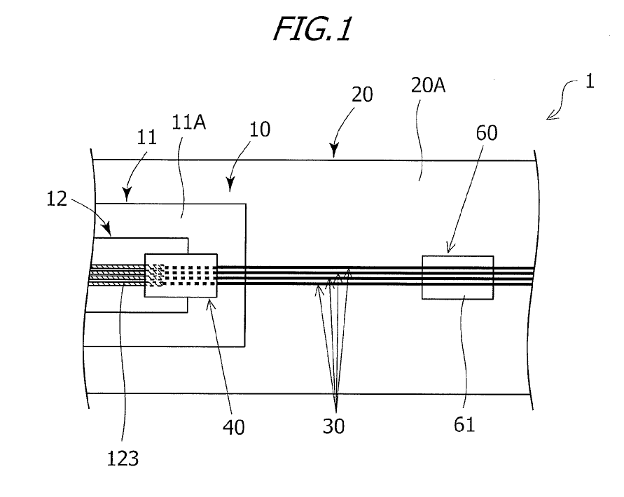

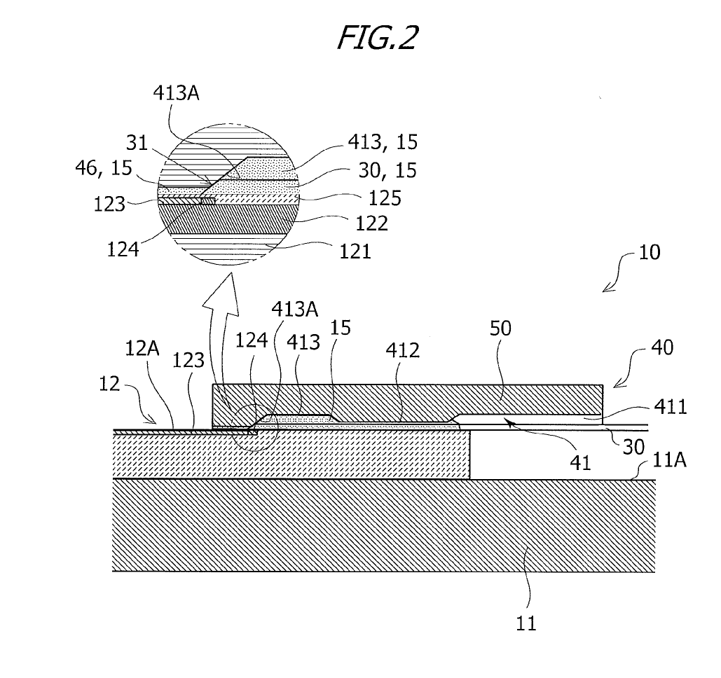

FIG. 1 is a configuration diagram of an optical communication apparatus 1 including a motherboard 20 on which an optical module 10, which is one example of an optical input-output device according to the embodiment, is placed. FIG. 2 is a sectional view of the optical module 10 according to the embodiment. In the optical module 10, an optical waveguide substrate 12, and a logic chip and a memory chip (both of which are not illustrated), or the like are mounted on an upper surface 11A of a package substrate 11. The optical waveguide substrate 12 is a semiconductor integrated chip where optical waveguides 123 are formed. The optical module 10 is mounted on the motherboard 20 by solder bumps (not illustrated).

The optical waveguide substrate 12 includes an optical fiber guide 40 that positions and mounts optical fibers 30. The optical fiber guide 40 is a guide member that guides the optical fibers 30 mounted on the optical waveguide substrate 12. Optical coupling units of the optical waveguides 123 formed on the optical waveguide substrate 12 and distal ends of the optical fibers 30 are positioned and optically coupled together by the optical fiber guide 40. Note that reference numeral 60 in the drawings denotes an optical fiber array in which the plurality of optical fibers 30 are arranged in an array, and which includes an optical ferule 61 and the optical fibers 30 held in the optical ferule 61. In the present embodiment, the four optical fibers 30 are held and arranged in the optical ferule 61. The optical communication apparatus 1 achieves optical interconnection by using the optical waveguides 123 and the optical fibers 30 optically coupled together as a transmission line for an optical signal. Note that a plurality of optical modules 10 placed on the motherboard 20 may be optically wired together by the optical fibers 30, or optical modules 10 of separate motherboards 20 may be optically wired together by the optical fibers 30.

<<Structure of the Optical Module>>

FIG. 2 illustrates a sectional structure of the optical module 10 around the optical waveguide substrate 12 on which the optical fiber guide 40 is installed. The optical waveguide substrate 12 is fabricated by using, for example, silicon photonics technology. The optical waveguide substrate 12 has a substrate structure in which a BOX (buried oxide) layer 122 is formed as a lower clad layer on a silicon layer 121. The BOX layer 122 is formed by, for example, silicon dioxide (SiO₂). The plurality of optical waveguides 123 are also formed in parallel as a core layer on the BOX layer 122. Optical coupling units 124 that are optically coupled to the optical fibers 30 are formed at end portions of the optical waveguides 123. The optical coupling units 124, also called grating couplers, are diffraction gratings formed, for example, by giving fine irregularity machining to the end portions of the optical waveguides 123. A clad layer 125 that covers the optical waveguides 123 is also formed on the BOX layer 122.

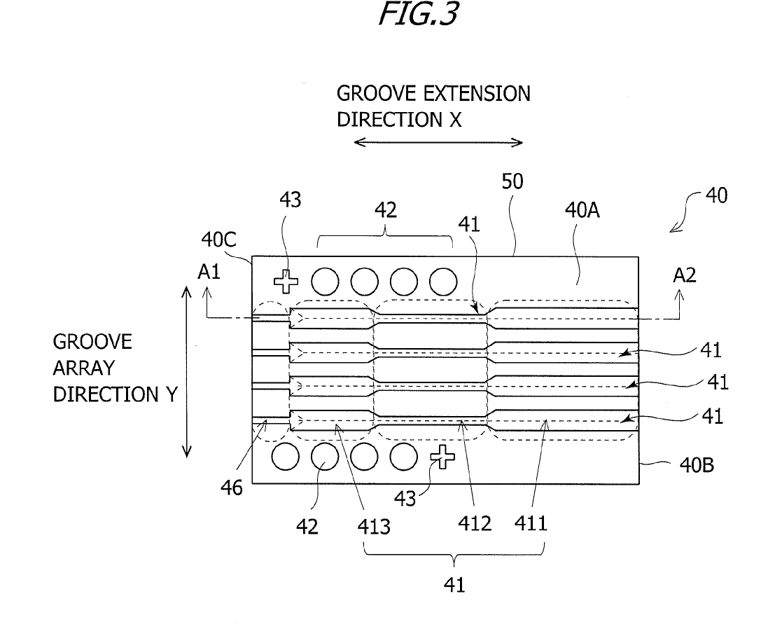

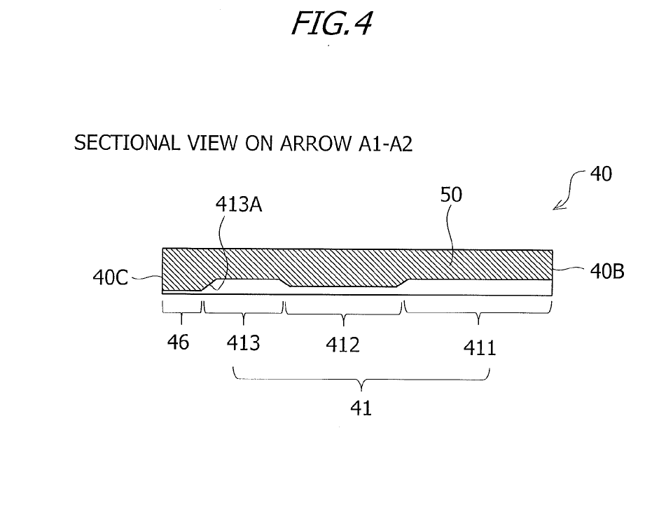

Next, a detailed structure of the optical fiber guide 40 is described. FIGS. 3 and 4 are views illustrating the optical fiber guide 40 according to the embodiment, and illustrate a state before the optical fiber guide 40 is installed on the optical waveguide substrate 12. FIG. 3 is a view illustrating a groove formation surface 40A of the optical fiber guide 40 according to the embodiment. FIG. 4 is a sectional view on an arrow A1-A2 illustrated in FIG. 3. The optical fiber guide 40 has an Si substrate 50 having a substantially rectangular parallelepiped shape, and the groove formation surface 40A that is a main surface of the optical fiber guide 40 (the Si substrate 50) has a rectangular plane surface.

A plurality of guide grooves 41 are provided in the groove formation surface 40A of the optical fiber guide 40. The plurality of guide grooves 41 formed in the groove formation surface 40A are arranged parallel to each other and at regular intervals. In the optical fiber guide 40, a direction in which the guide grooves 41 extend is referred to as a “groove extension direction X”. A direction in which the respective guide grooves 41 are arranged, that is, a direction perpendicular to the groove extension direction X in the groove formation surface 40A is referred to as a “groove array direction Y”. In an example of the optical fiber guide 40 illustrated in FIG. 3, the groove extension direction X corresponds to a long side direction of the groove formation surface 40A, and the groove array direction Y corresponds to a short side direction of the groove formation surface 40A. One end of each of the guide grooves 41 opens in a side surface on one short side (referred to as a “first short side” below) 40B-side of the groove formation surface 40A, so that the optical fiber 30 can be inserted from the opening. As illustrated in FIGS. 3 and 4, the other end sides of the guide grooves 41 do not reach a short side (referred to as a “second short side” below) 40C opposed to the first short side 40B. Also, although the four guide grooves 41 are formed in the groove formation surface 40A of the optical fiber guide 40 in the present embodiment, the number thereof is not particularly limited.

Each of the guide grooves 41 of the optical fiber guide 40 includes an optical fiber introduction unit 411, an optical fiber adjustment unit 412, and an optical fiber positioning unit 413. In the guide groove 41, the optical fiber introduction unit 411, the optical fiber adjustment unit 412, and the optical fiber positioning unit 413 are sequentially provided in this order from the first short side 40B-side. The optical fiber introduction unit 411 forms a proximal end portion of the guide groove 41, the optical fiber positioning unit 413 forms a distal end portion of the guide groove 41, and the optical fiber adjustment unit 412 sandwiched therebetween forms an intermediate portion of the guide groove 41. Reference numeral 46 in FIGS. 3 and 4 denotes an “adhesive introduction groove” through which an adhesive for fixing the optical fiber 30 is introduced from outside. In the adhesive introduction groove 46, one end connects with the optical fiber positioning unit 413 of the guide groove 41, and the other end opens in a side surface on the second short side 40C-side.

The adhesive introduction groove 46, and the optical fiber introduction unit 411 and the optical fiber positioning unit 413 of the guide groove 41 are formed as V grooves having a V shape. On the other hand, the optical fiber adjustment unit 412 of the guide groove 41 is formed as a rectangular groove having a rectangular section. Here, a groove width of the optical fiber adjustment unit 412 is smaller than groove widths of the optical fiber introduction unit 411 and the optical fiber positioning unit 413. Also, the optical fiber introduction unit 411 and the optical fiber positioning unit 413 have groove widths and groove depths equal to each other. A groove width and a groove depth of the adhesive introduction groove 46 are smaller than those of the optical fiber positioning unit 413 of the guide groove 41, respectively.

In the present embodiment, a slide inclined surface 413A is formed in a boundary portion between the optical fiber positioning unit 413 and the adhesive introduction groove 46. The slide inclined surface 413A is inclined at a preset angle with respect to the groove extension direction X that is an axial direction of the guide groove 41.

A plurality of connection pads 42 and a plurality of alignment marks 43 are formed on the groove formation surface 40A of the optical fiber guide 40. The connection pads 42 are pads on which pre-solder is formed in flip-chip mounting the optical fiber guide 40 on the optical waveguide substrate 12. Also, the alignment marks 43 are marks used for performing alignment in flip-chip mounting the optical fiber guide 40 on the optical waveguide substrate 12. The numbers, positions or the like of the connection pads 42 and the alignment marks 43 disposed on the optical fiber guide 40 can be freely changed.

In the present embodiment, the optical fiber guide 40 is flip-chip mounted on a guide mounting surface 12A of the optical waveguide substrate 12. In a manufacturing process of the optical module 10, the optical fibers 30 are inserted into the guide grooves 41 from the optical fiber introduction units 411-side after mounting the optical fiber guide 40 on the optical waveguide substrate 12. After the optical fibers 30 are positioned, an adhesive 15 is introduced from the adhesive introduction grooves 46, so that the optical fibers 30 are fixed. As a result, as illustrated in FIG. 2, the optical fibers 30 are mounted on the optical waveguide substrate 12 in a state aligned with the optical coupling units 124. In the present embodiment, the optical fiber guide 40 is fixed to the optical waveguide substrate 12 such that the optical waveguides 123, the guide grooves 41 (the optical fiber introduction units 411, the optical fiber adjustment units 412, and the optical fiber positioning units 413), and the adhesive introduction grooves 46 are parallel to a planar direction.

<<Method for Manufacturing the Optical Fiber Guide>>

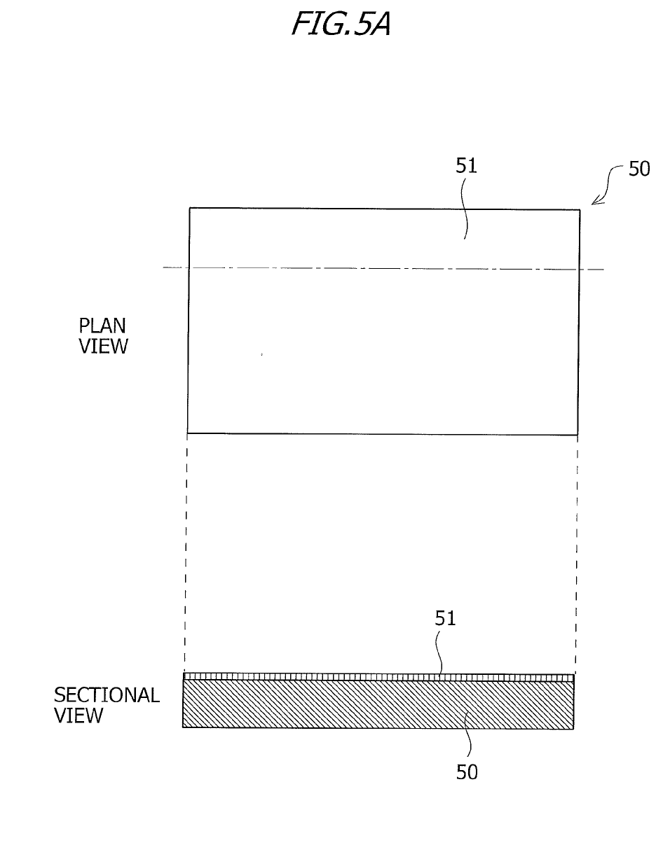

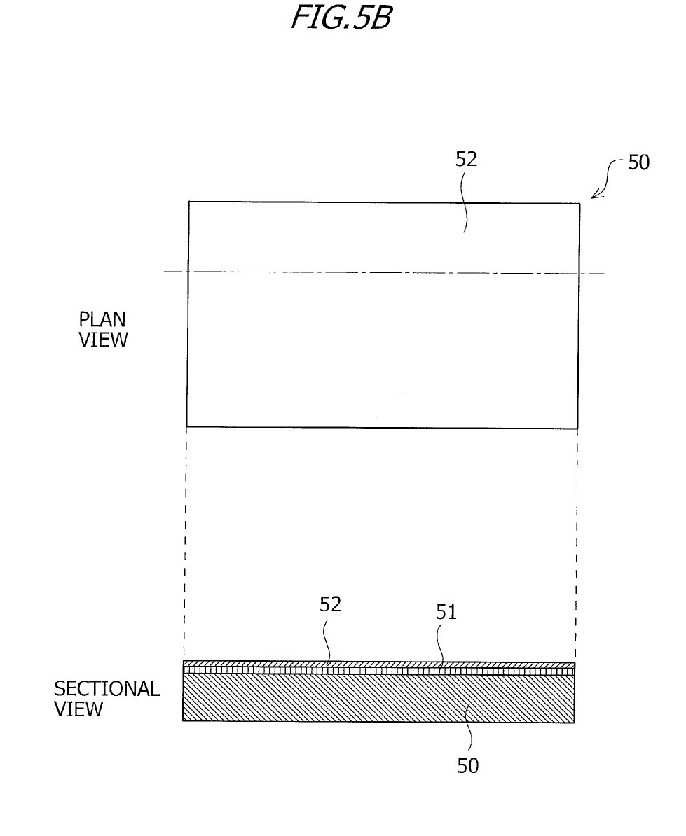

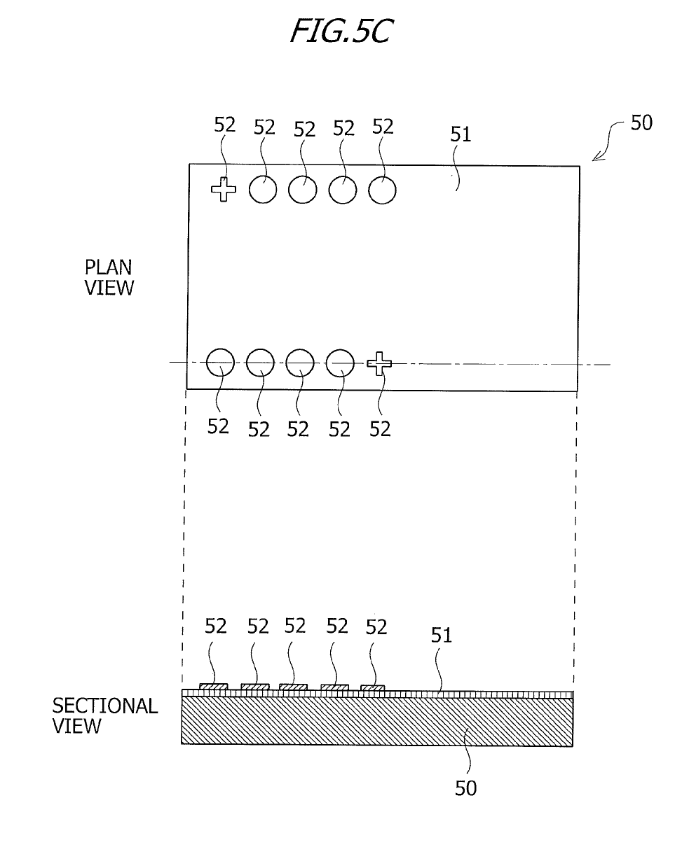

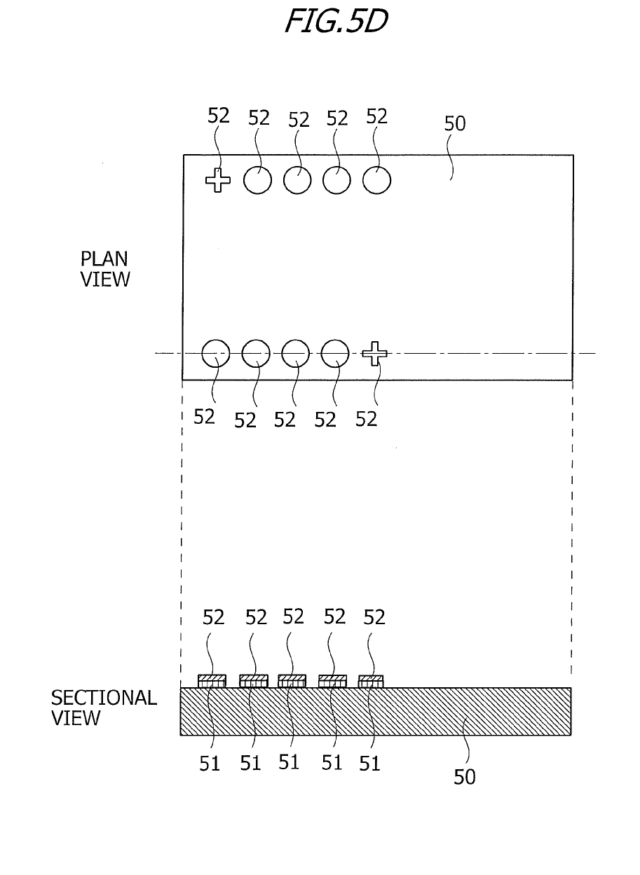

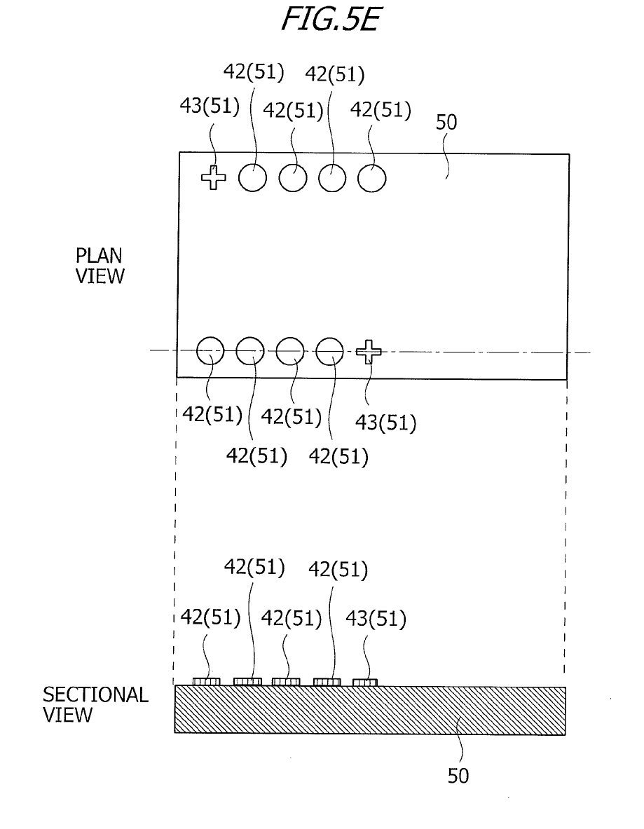

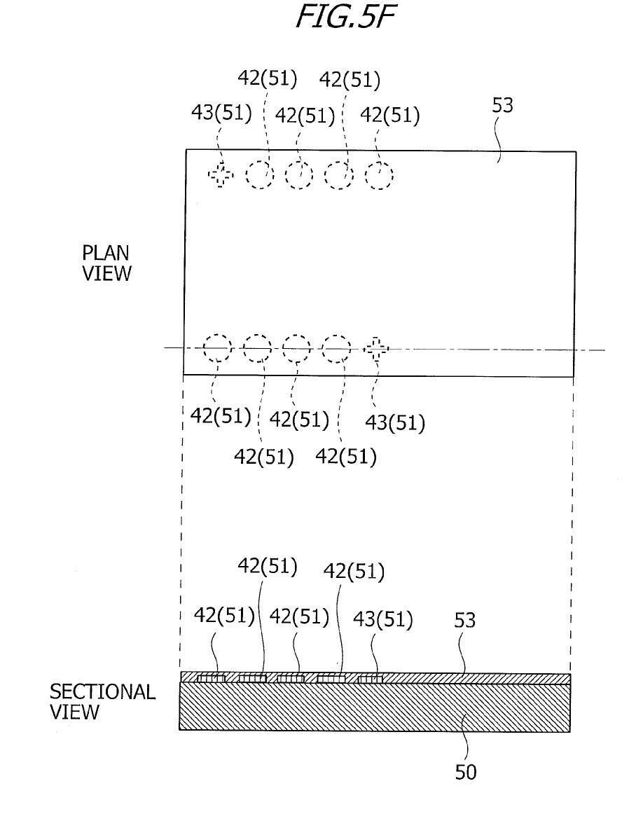

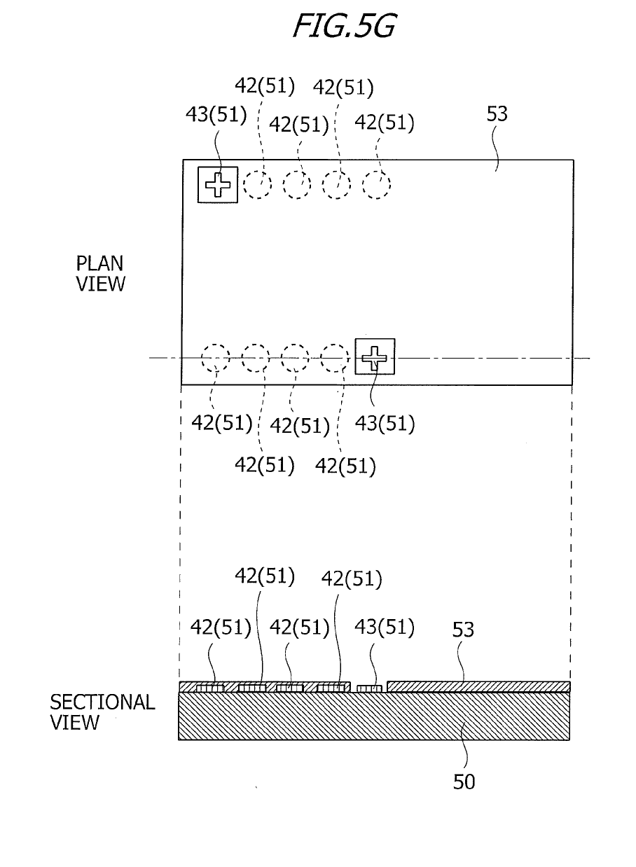

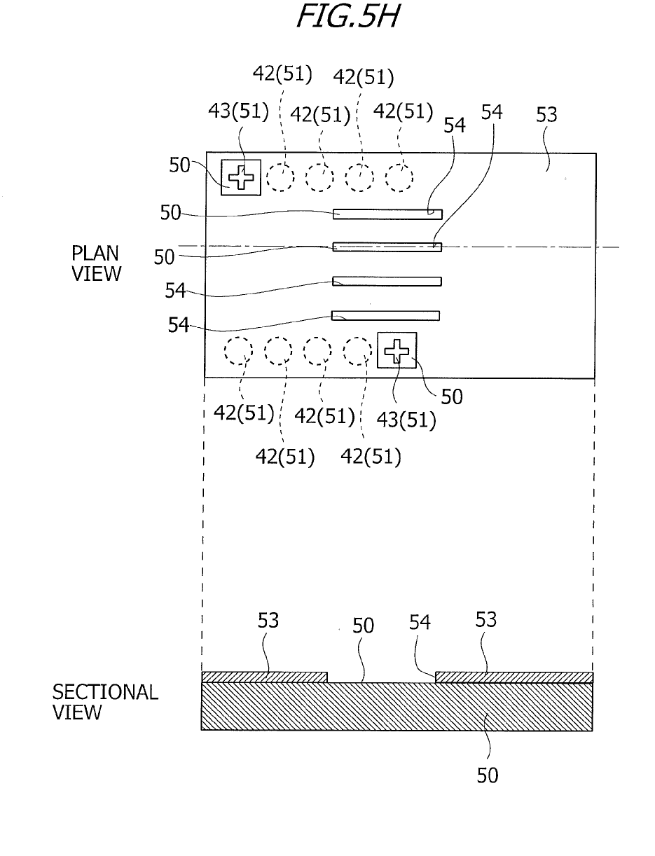

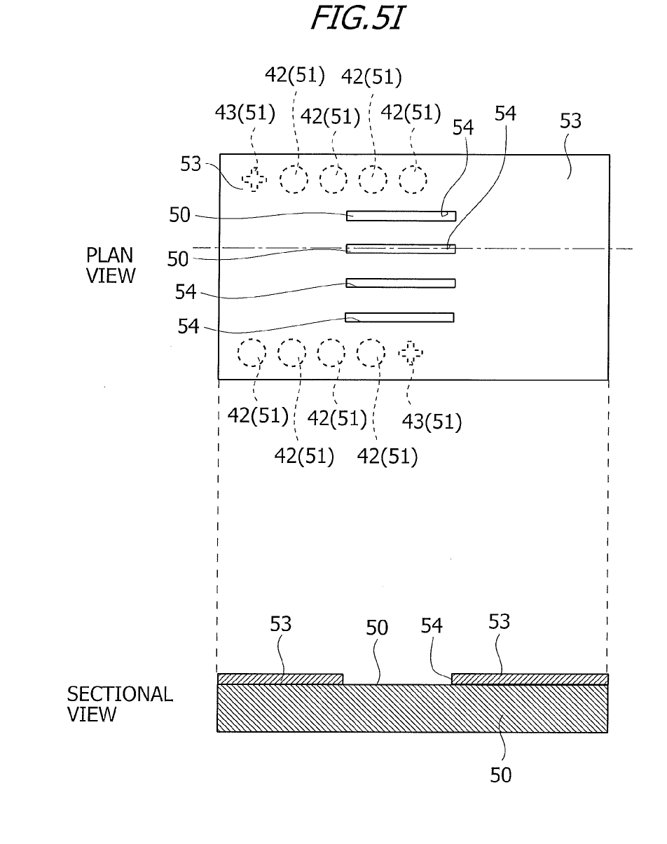

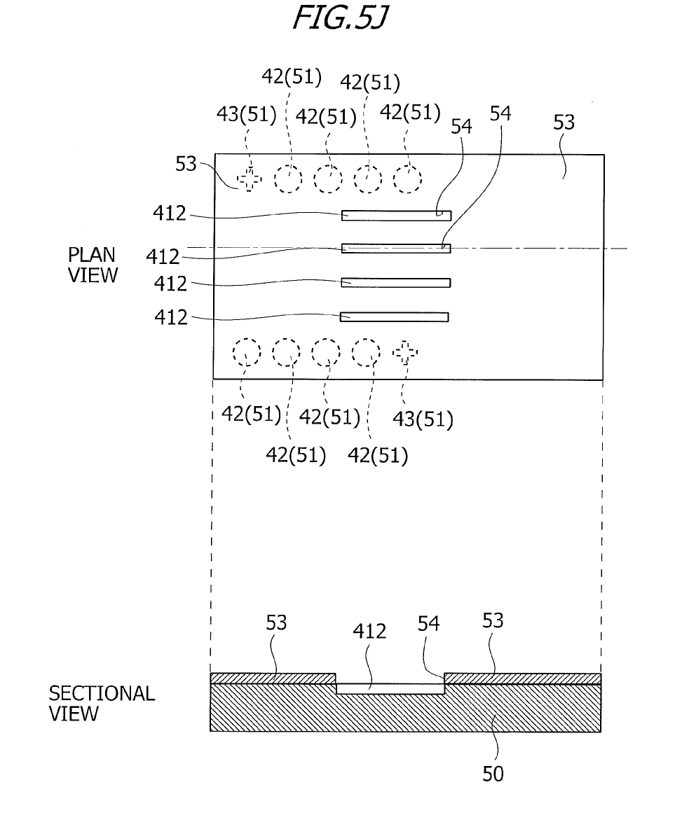

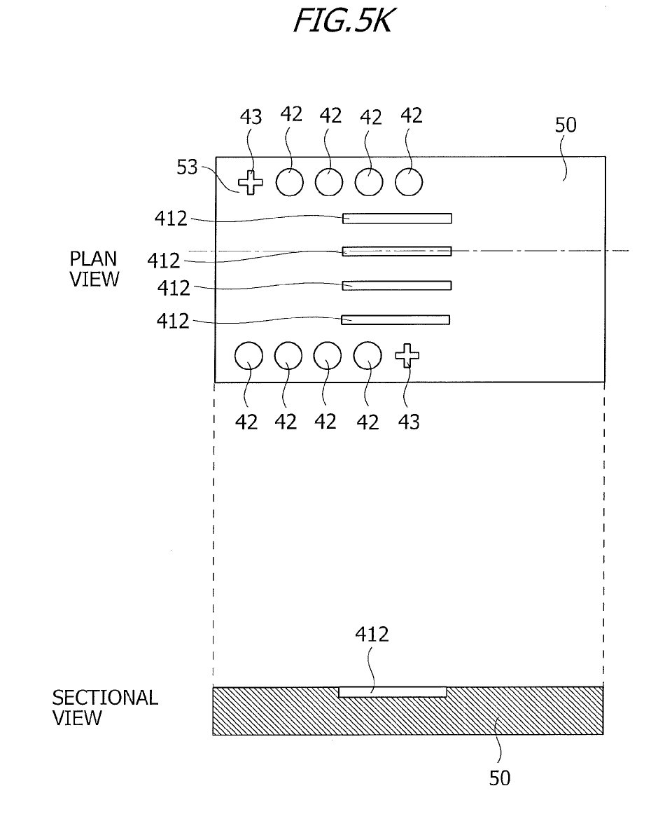

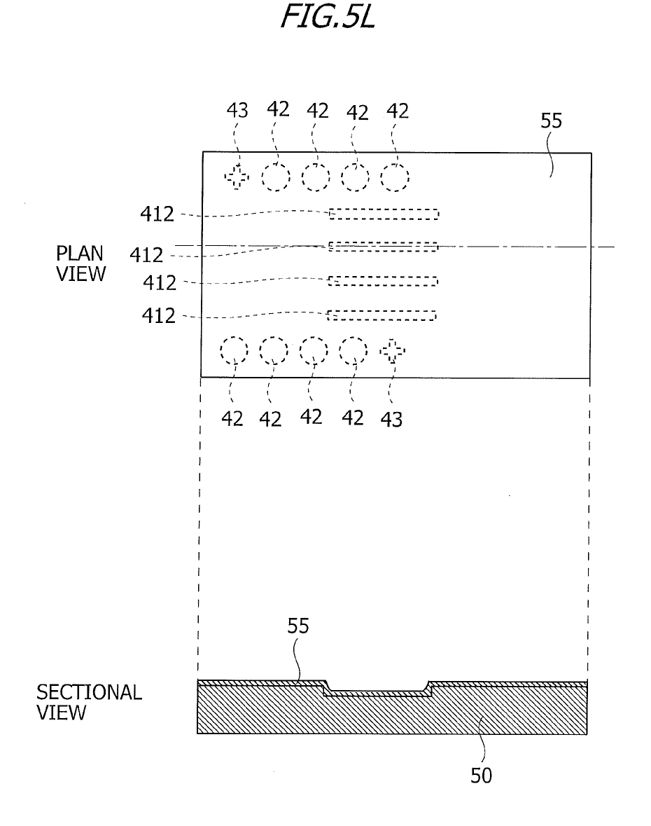

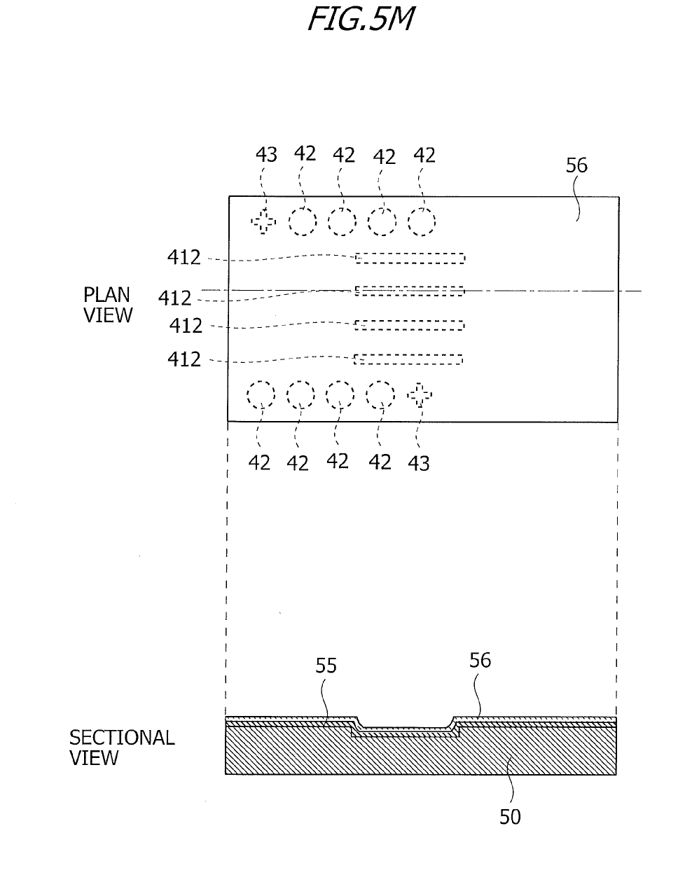

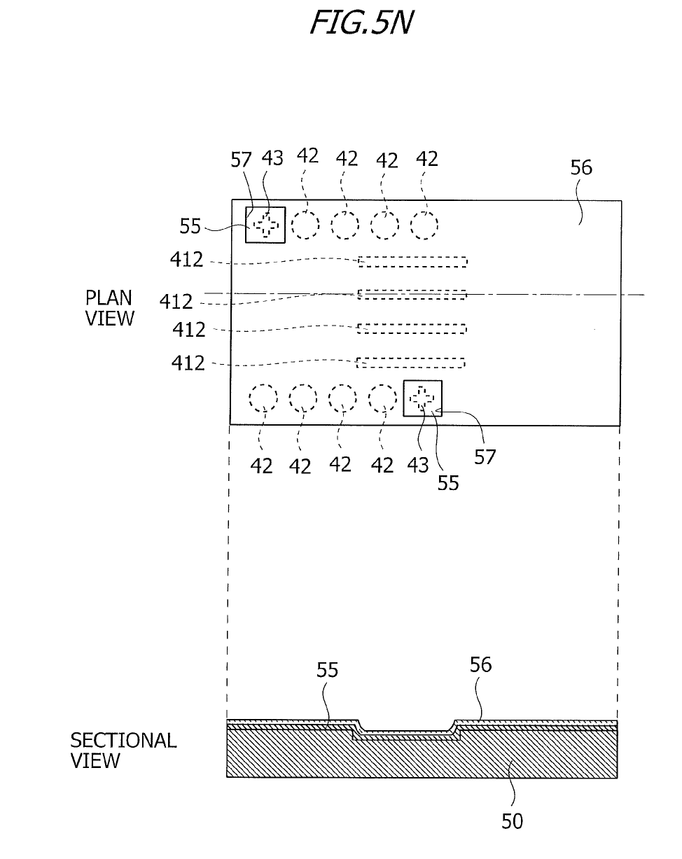

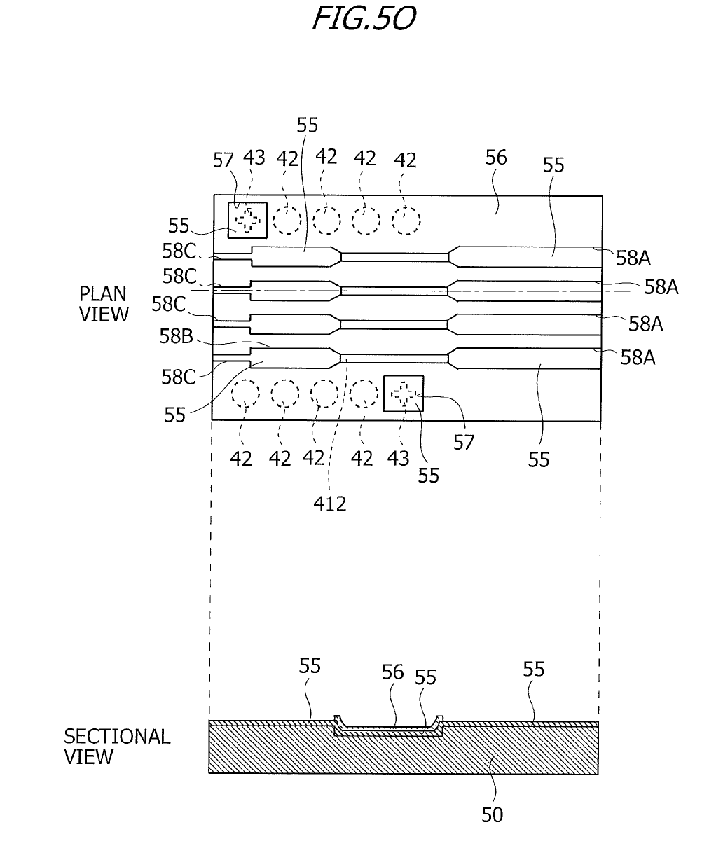

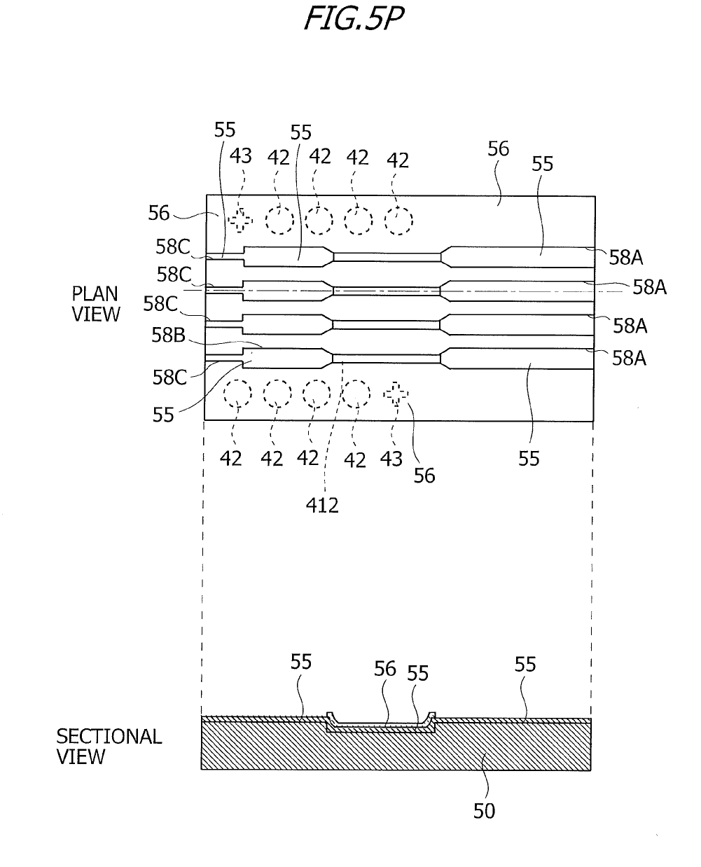

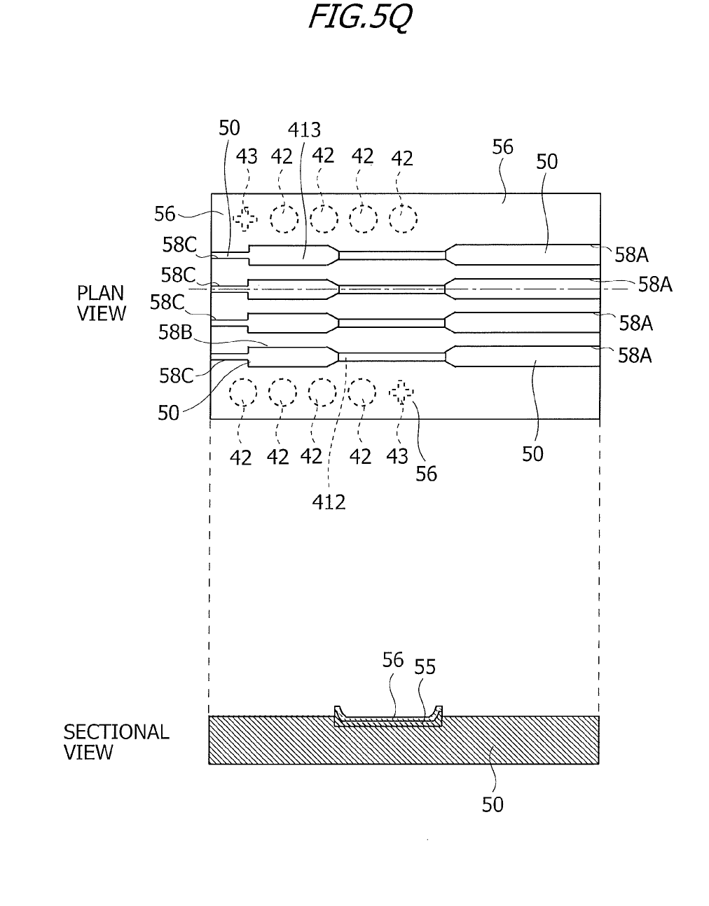

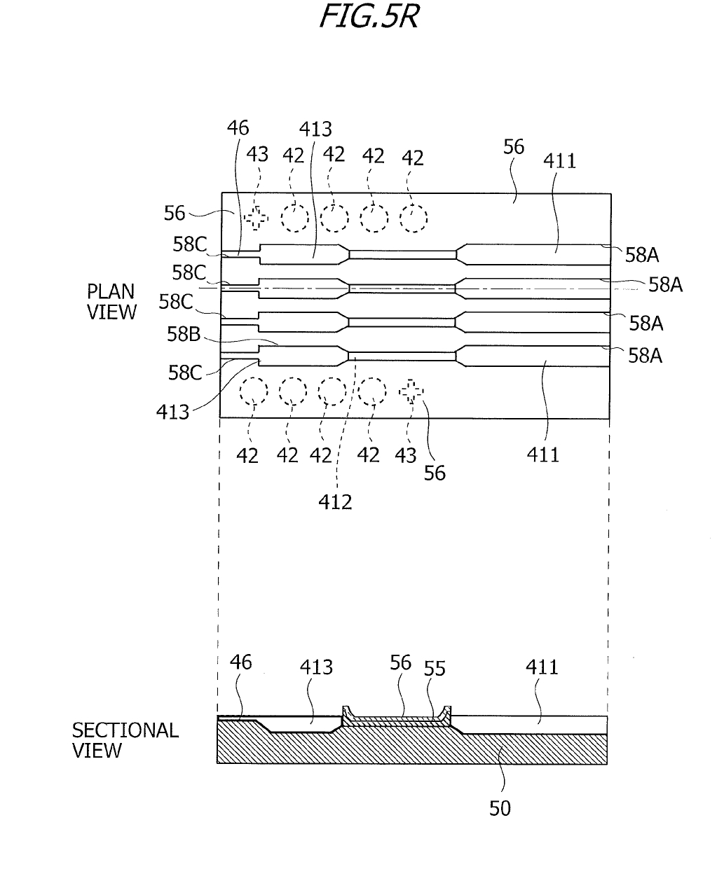

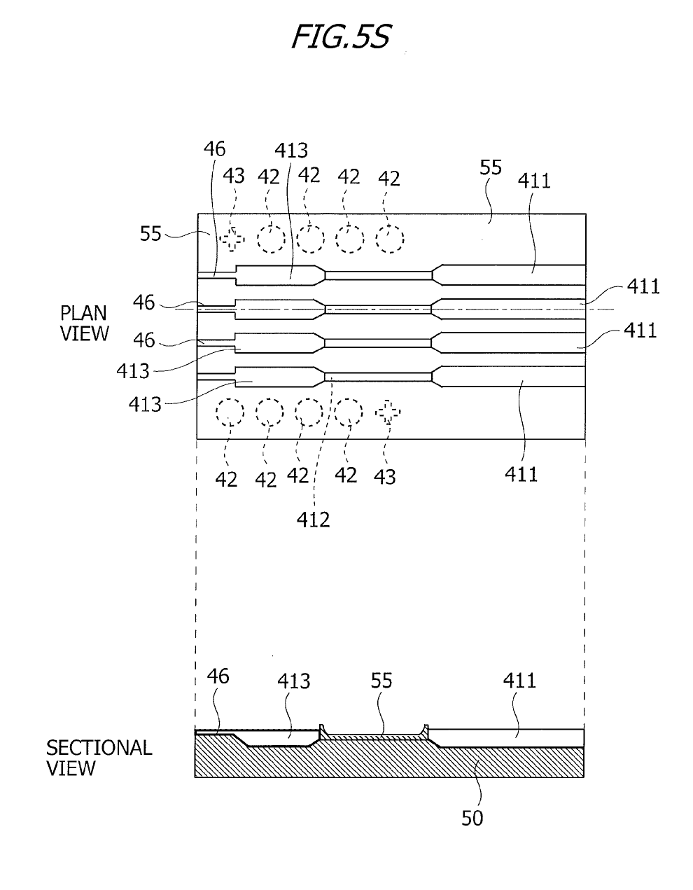

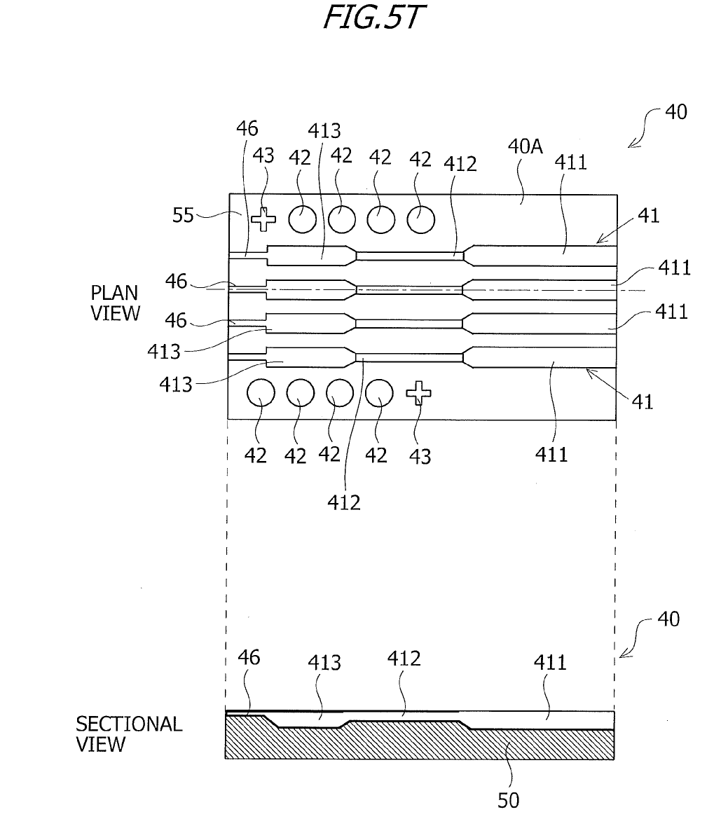

Next, steps of manufacturing the optical fiber guide 40 according to the embodiment are described. FIGS. 5A to 5T are views illustrating the steps of manufacturing the optical fiber guide 40. Note that, in FIGS. 5A to 5T, upper stages in the drawings illustrate plan views for explaining the respective steps, and lower stages in the drawings illustrate sectional views for explaining the respective steps. Also, in FIGS. 5A to 5T, alternate long and short dash lines in the plan views indicate positions of sections illustrated in the lower stages.

At the time of manufacturing the optical fiber guide 40, first, the connection pads 42 and the alignment marks 43 are formed on the main surface of the Si (silicon) substrate 50 by the steps illustrated in FIGS. 5A to 5E. To be more specific, a metal layer 51 is first formed on the entire main surface of the Si substrate 50 having a rectangular plane surface as illustrated FIG. 5A. The metal layer 51 is a laminated film where a Ti (titanium) layer, a Pt (platinum) layer, and an Au (gold) layer are laminated in this order on the Si substrate 50. The metal layer 51 can be formed by, for example, a sputtering method. As a specific example, an aspect is given in which a metal laminated film of a 5-nm Ti layer, a 1000-nm Pt layer, and a 100-nm Au layer is formed on an Si chip having a thickness of about 0.6 nm by using a sputtering system (manufactured by ULVAC, Inc., model name: MLX3000N). Note that a long side direction of the Si substrate 50 corresponds to the groove extension direction X of the optical fiber guide 40. Also, a short side direction of the Si substrate 50 corresponds to the groove array direction Y of the optical fiber guide 40.

Subsequently, a first resist layer 52 is formed on the metal layer 51 as illustrated in FIG. 5B. Then, as illustrated in FIG. 5C, the first resist layer 52 is removed other than portions to become the connection pads 42 and the alignment marks 43 by pattering the first resist layer 52. As a specific example, a photoresist (manufactured by AZ Electronic Materials plc, model name: AZ-P4620) may be applied by a spin coating method. The photoresist may be exposed to light at an exposure of 400 mJ/cm² by using a glass mask and a contact exposure system (USHIO INC., model name: UX3), and may be patterned by using a developer (manufactured by AZ Electronic Materials plc, product name: AZ developer).

Subsequently, after removing the metal layer 51 as illustrated in FIG. 5D, the first resist layer 52 is removed, so that the connection pads 42 and the alignment marks 43 are formed as illustrated in FIG. 5E. As a specific example, the photoresist may be removed by using acetone after removing the metal laminated film by use of an ion beam milling system (Hakuto Co., Ltd., model name: 7.5IBE). As a result, the connection pads 42 and the alignment marks 43 having a three-layer structure of Ti/Pt/Au can be fabricated. Here, although a height of the connection pads 42 is not particularly limited, for example, an aspect is given in which the height is about 0.1 to 20 μm. It is also preferable to set the height of the connection pads 42 to 0.5 to 4 μm.

Next, the optical fiber adjustment units 412 of the optical fiber guide 40 are formed by the steps illustrated in FIGS. 5F to 5K. That is, as illustrated in FIG. 5F, a second resist layer 53 is applied onto the main surface of the Si substrate 50 on which the connection pads 42 and the alignment marks 43 are formed. As a specific example, a photoresist (manufactured by AZ Electronic Materials plc, model name: AZ-P4620) may be applied by a spin coating method.

Subsequently, as illustrated in FIG. 5G, the alignment marks 43 are exposed by patterning the second resist layer 53 based on an outer shape of the Si substrate 50. Then, as illustrated in FIG. 5H, the surface of the Si substrate 50 in portions where the optical fiber adjustment units 412 are to be formed is exposed by patterning the second resist layer 53. As a specific example, after the second resist layer 53 is exposed to light by using the exposure system, and the alignment marks 43 are exposed by using the developer in a similar manner to the patterning of the first resist layer 52, resist openings 54 for deep etching of the optical fiber adjustment units 412 may be formed. By patterning the resist openings 54 for deep etching of the optical fiber adjustment units 412 based on the alignment mark 43 exposed outside, the optical fiber adjustment units 412 can be accurately formed in the subsequent steps.

Subsequently, as illustrated in FIG. 5I, the alignment marks 43 are masked by the second resist layer 53. Then, as illustrated in FIG. 5J, the optical fiber adjustment units 412 having a rectangular groove shape are formed by performing deep etching on the Si substrate 50 through the resist openings 54. As a specific example, the alignment marks 43 may be masked by applying the photoresist to resist openings where the alignment marks 43 are exposed by use of a minute application dispenser, and drying the photoresist. After that, a deep groove may be formed by a bosch process in which etching by SF6 gas and protective film formation by C4H8 gas are repeated by using a reactive ion etching system (manufactured by SAMCO Inc., model name: RIE-200iPB).

As illustrated in FIG. 5J, the optical fiber adjustment units 412 are formed extending in the long side direction (corresponding to the groove extension direction X of the optical fiber guide 40) of the Si substrate 50. The plurality of optical fiber adjustment units 412 are also arranged in parallel at regular intervals in the short side direction (corresponding to the groove array direction Y of the optical fiber guide 40) of the Si substrate 50. Although the arrangement number of the optical fiber adjustment units 412 is four in the present embodiment, the present adjustment is not limited thereto. Also, although the optical fiber adjustment units 412 are formed as rectangular grooves having a width of 127 μm and a depth of 200 μm in the present embodiment, the present invention is not limited thereto.

Subsequently, as illustrated in FIG. 5K, the second resist layer 53 is removed by using acetone or the like. As a result, the Si substrate 50 where the plurality of optical fiber adjustment units 412 are arranged in parallel on the main surface is obtained.

Next, the optical fiber introduction units 411, the optical fiber positioning units 413, and the adhesive introduction grooves 46 are formed by the steps illustrated in FIGS. 5L to 5T, so that the fabrication of the optical fiber guide 40 is completed. First, as illustrated in FIG. 5L, an SiO₂ layer 55 is formed on the entire surface of the Si substrate 50 where the optical fiber adjustment units 412 are formed. As a specific example, an SiO₂ layer having a thickness of about 2 μm may be formed by using a plasma CVD system (manufactured by SAMCO Inc., model name: PD-220LN).

Subsequently, as illustrated in FIG. 5M, a third resist layer 56 is formed on an entire surface of the SiO₂ layer 55. As a specific example, a photoresist (model name: AZ-P4620) may be formed by a spray coating method by using a spray coater (manufactured by Sanmei Electronics Co., Ltd.). Then, as illustrated in FIG. 5N, resist openings 57 are formed above the alignment marks 43 by patterning the third resist layer 56. As a specific example, the third resist layer 56 may be exposed to light by using the contact exposure system, and the resist openings 57 may be formed by using the developer in a similar manner to the patterning of the first resist layer 52.

Subsequently, as illustrated in FIG. 5O, resist openings 58A to 58C are formed such that the SiO₂ layer 55 is exposed at positions where the optical fiber introduction units 411, the optical fiber positioning units 413 and the adhesive introduction grooves 46 are formed by patterning the third resist layer 56. Note that the resist openings 58A correspond to the optical fiber introduction units 411, the resist openings 58B correspond to the optical fiber positioning units 413, and the resist openings 58C correspond to the adhesive introduction grooves 46. As a specific example, the third resist layer 56 may be exposed to light by using the contact exposure system, and the resist openings may be formed by using the developer in a similar manner to the patterning of the first resist layer 52.

Here, in the step illustrated in FIG. 5O, the resist openings 58A to 58C are formed based on the alignment marks 43 that are located within the resist openings 57 formed in the step illustrated in FIG. 5N. At this time, although the alignment marks 43 are covered with the SiO₂ layer 55, the resist openings 58A to 58C can be accurately formed by recognizing the alignment marks 43 through the SiO₂ layer 55.

Subsequently, in the step illustrated in FIG. 5P, the alignment marks 43 are masked by the third resist layer 56. Then, in the step illustrated in FIG. 5Q, a Si layer of the Si substrate 50 is exposed by performing etching on the SiO₂ layer 55 exposed from the resist openings 58A to 58C of the third resist layer 56. As a specific example, the Si layer may be exposed by performing etching on the SiO₂ layer by use of a reactive ion etching system (manufactured by SAMCO Inc., model name: RIE-200iPB).

Subsequently, in the step illustrated in FIG. 5R, the optical fiber introduction units 411, the optical fiber positioning units 413, and the adhesive introduction grooves 46 are formed by performing anisotropic etching on the Si layer of the Si substrate 50 exposed in the step illustrated in FIG. 5Q. As a specific example, an aspect is given in which the Si substrate 50 is subjected to crystal anisotropic etching by using a tetramethylammonium hydroxide solution (TMAH). In the present embodiment, the adhesive introduction grooves 46 are formed as V grooves having a width of 28 μm, a depth of 20 μm, and a length of 1 mm. Also, the optical fiber introduction units 411 are formed as V grooves having a width of 232 μm, a depth of 164 μm, and a length of 2 mm. Also, the optical fiber positioning units 413 are formed as V grooves having a width of 232 μm, a depth of 164 μm, and a length of 1 mm, and having the inclined surfaces with an inclination angle of 54.7 degrees at boundary positions with the adhesive introduction grooves 46. Also, an interval of arranging the respective V grooves in a widthwise direction of the Si substrate 50 is set to 250 μm. Note that, in the crystal anisotropic etching, an inclination angle of the V groove with respect to the main surface is 54.7 degrees due to crystal anisotropy. Therefore, a depth of the V groove is unequivocally determined by a width of the V groove, that is, a width of the resist opening portion formed in the third resist layer 56 in the step illustrated in FIG. 5Q.

Subsequently, in the step illustrated in FIG. 5S, the third resist layer 56 is removed by using acetone, and in the step illustrated in FIG. 5T, the SiO₂ layer 55 on the main surface of the Si substrate 50 is removed. Here, an aspect is given as an example in which the SiO₂ layer 55 is removed by using buffered hydrogen fluoride (BHF). Through the above steps illustrated in FIGS. 5A to 5T, the optical fiber guide 40 illustrated in FIGS. 3 and 4 can be manufactured.

<<Mounting of the Optical Fiber Guide on the Optical Waveguide Substrate>>

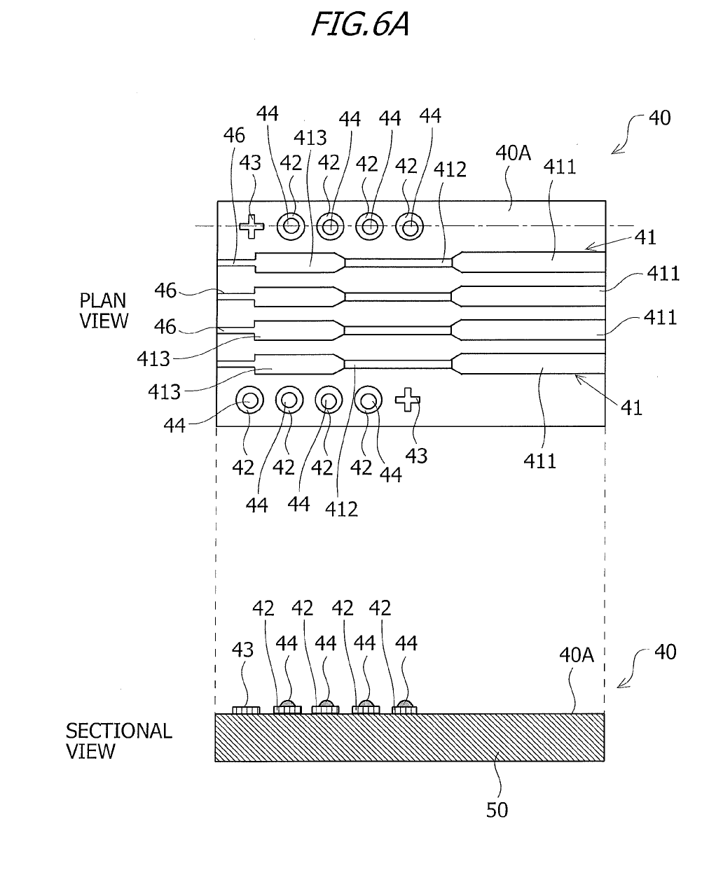

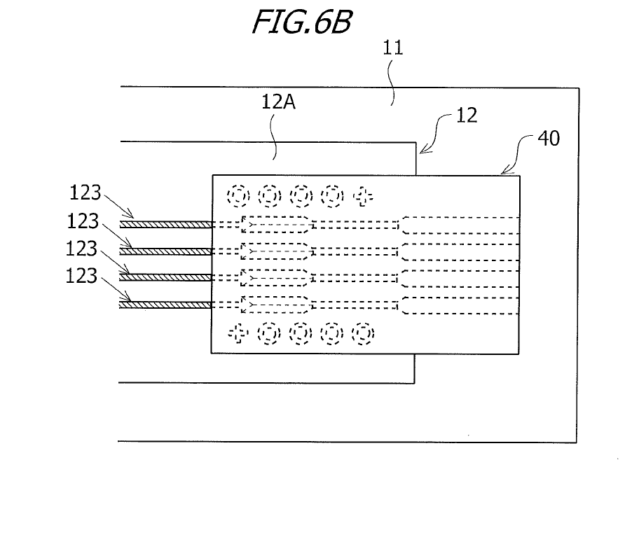

Next, steps of mounting the optical fiber guide 40 on the optical waveguide substrate 12 are described with reference to FIGS. 6A and 6B. In FIG. 6A, an upper stage in the drawing illustrates a plan view of each step, and a lower stage in the drawing illustrates a sectional view of each step.

First, as illustrated in FIG. 6A, a solder paste such as gold tin (AuSn) solder is applied to the connection pads 42 formed on the groove formation surface 40A of the optical fiber guide 40, and pre-solder 44 having an approximately semispherical shape is thereafter formed on the connection pads 42 by reflow treatment. As a specific example, 20 pl (pico liters) of gold tin (AuSn) solder paste may be applied onto the connection pads 42 by using a minute application dispenser (manufactured by Applied Microsystems, Inc.), and the solder may be melted by reflow treatment to form pre-solder having a diameter of 25 μm.

Here, the optical waveguide substrate 12 having the optical waveguides 123 as described based on FIG. 2 is prepared. The number of the optical waveguides 123 in the optical waveguide substrate 12 corresponds to the number of the guide grooves 41 in the optical fiber guide 40, and in the present embodiment, is four. Also, connection pads and alignment marks corresponding to the connection pads 42 and the alignment marks 43 of the optical fiber guide 40 are previously formed on the guide mounting surface 12A of the optical waveguide substrate 12.

As illustrated in FIG. 6B, the optical fiber guide 40 is flip-chip mounted on the optical waveguide substrate 12. As a specific example, the optical fiber guide 40 may be flip-chip mounted on the optical waveguide substrate 12 at a load of 2.0 kgf and a tool temperature of 380° C. by using a flip chip bonder (manufactured by Toray Engineering Co., Ltd., model name: OF2000). In the present embodiment, a tool that suctions the optical fiber guide 40 is heated to a high temperature when the optical fiber guide 40 is flip-chip mounted. Accordingly, the connection pads of the optical waveguide substrate 12 and the connection pads 42 of the optical fiber guide 40 are metal-joined with the re-molten AuSn solder becoming a brazing material, and a metal layer having a five-layer configuration of a Ti layer/a Pt layer/an AuSn layer/a Pt layer/a Ti layer is formed.

Also, as illustrated in FIG. 6B, the optical fiber guide 40 is fixed to the optical waveguide substrate 12 in a state in which a region where the optical fiber introduction units 411 are formed projects laterally from the optical waveguide substrate 12. Also, the optical waveguide substrate 12 is soldered and mounted onto the package substrate 11 of the optical module 10. The soldering mounting of the optical waveguide substrate 12 may be performed before or after mounting the optical fiber guide 40 on the optical waveguide substrate 12. Through the above steps, the optical module 10 including the optical waveguide substrate 12 having the optical fiber guide 40 is obtained.

<<Alignment Mounting of the Optical Fibers>>

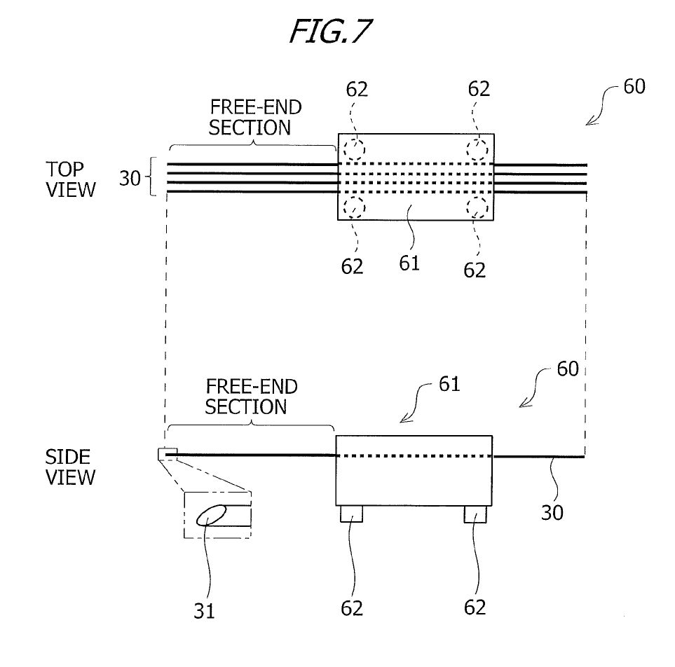

Next, alignment mounting of the optical fibers 30 in the present embodiment is described. FIG. 7 is a configuration diagram of the optical fiber array 60 according to the embodiment. An upper stage in FIG. 7 illustrates a top view of the optical fiber array 60, and a lower stage illustrates a side view of the optical fiber array 60. The optical fiber array 60 includes the optical ferule 61 that holds the optical fibers 30, and the plurality of optical fibers 30 that are arranged in an array in the optical ferule 61. The optical ferule 61 has a substantially rectangular parallelepiped shape, and is a molded body obtained by molding, for example, a resin. Cylindrical protrusions 62 are provided at four corners on a lower surface of the optical ferule 61. As illustrated in FIG. 7, the four optical fibers 30 are held in the optical ferule 61. Also, in each of the optical fibers 30, a distal-end inclined surface 31 is formed by obliquely cutting the distal end thereof. An inclination angle of the distal-end inclined surface 31 with respect to an optical axis of the optical fiber 30 is 54.7 degrees. In the following, a side of the optical ferule 61 closer to the distal-end inclined surface 31-side of the optical fiber 30 is defined as a front side. The distal-end inclined surfaces 31 of the respective optical fibers 30 held in the optical ferule 61 are all aligned in the same direction so as to be directed to an obliquely upward front.

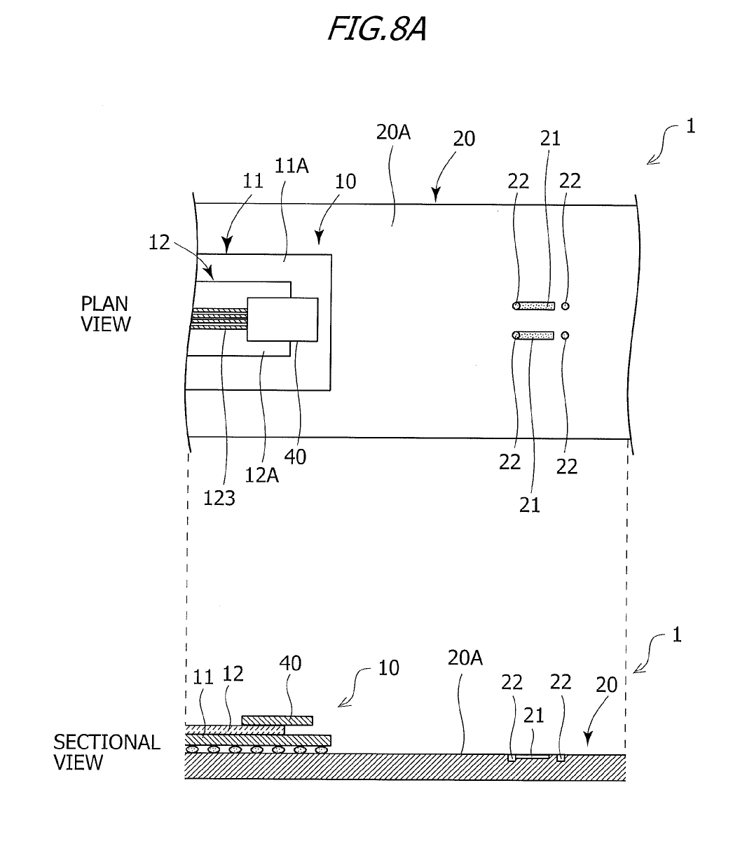

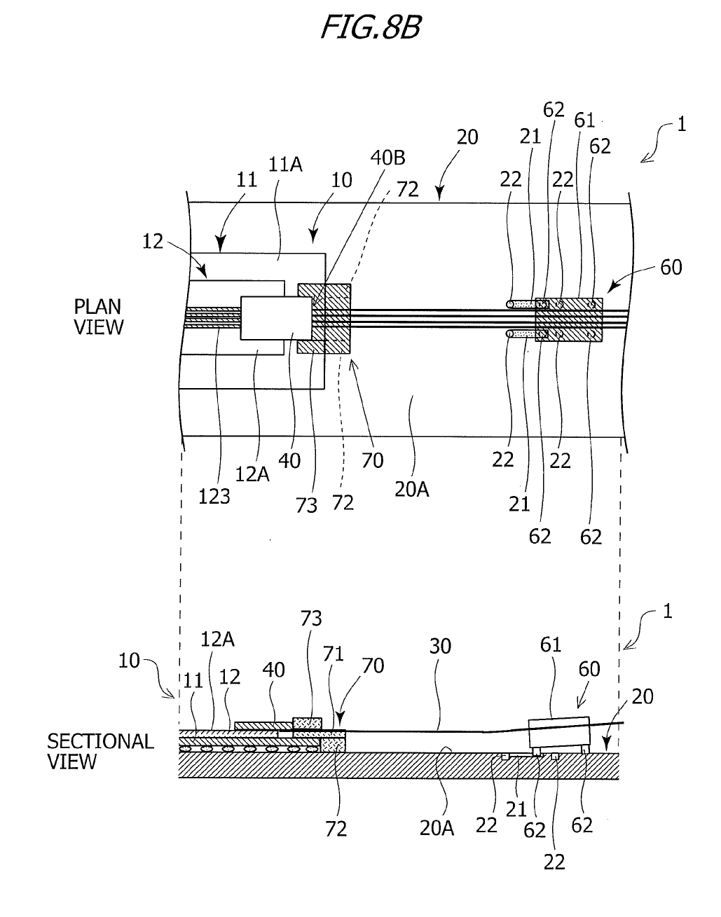

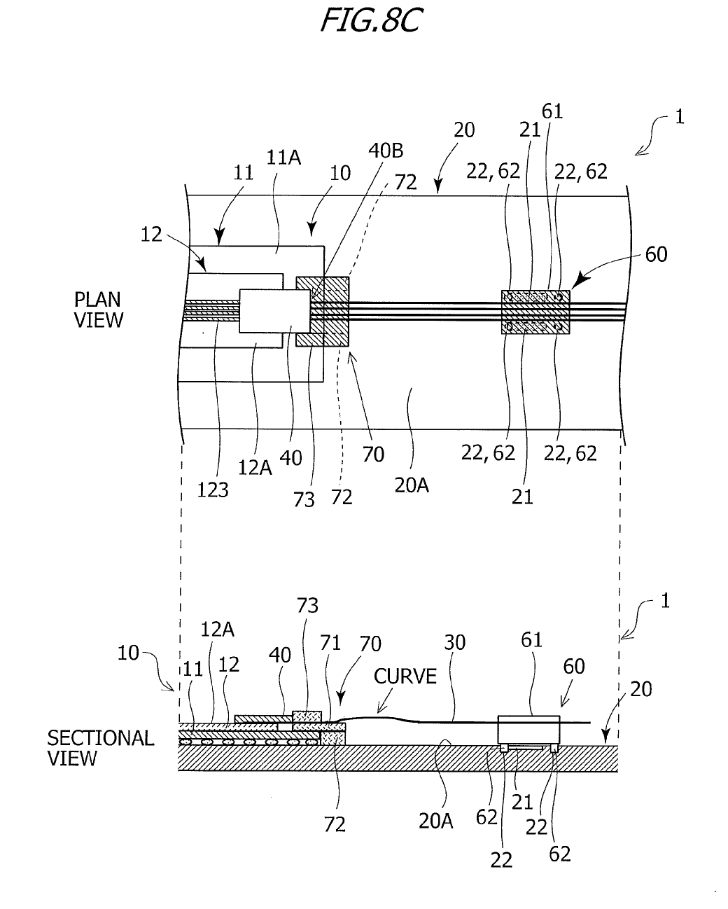

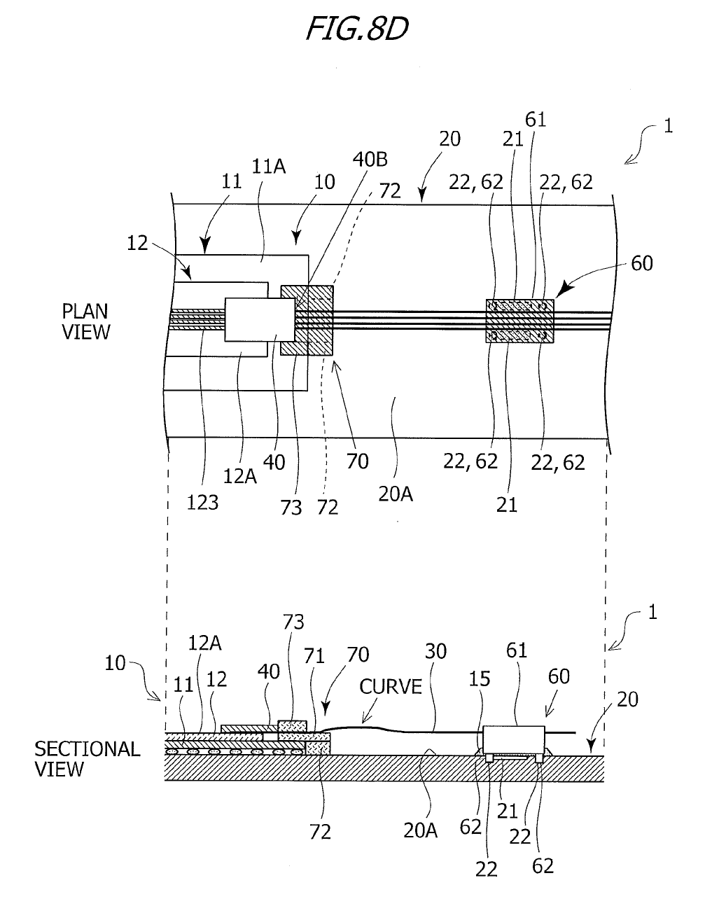

Next, steps of mounting the optical fibers 30 according to the embodiment are described with reference to FIGS. 8A and 8D. Note that, in FIGS. 8A to 8D, upper stages in the drawings illustrate plan views for explaining the respective steps, and lower stages in the drawings illustrate sectional views for explaining the respective steps.

At the time of mounting the optical fibers 30, first, the motherboard 20 illustrated in FIG. 8A is prepared. The optical module 10 is previously mounted on an upper surface 20A of the motherboard 20. A pair of slide grooves 21 extending parallel to center axes of the guide grooves 41 of the optical fiber guide 40 mounted on the optical waveguide substrate 12 of the optical module 10 are also previously formed in the upper surface 20A of the motherboard 20. The pair of slide grooves 21 can receive and slide the cylindrical protrusions 62 provided on the lower surface of the optical ferule 61 illustrated in FIG. 7. A width of the slide grooves 21 is set to a size equal to or slightly larger than a diameter of the protrusions 62 on the optical ferule 61. By fitting the protrusions 62 of the optical ferule 61 into the slide grooves 21 of the motherboard 20, the optical ferule 61 can be slid along an extension direction of the slide grooves 21, that is, the extension direction of the guide grooves 41 of the optical fiber guide 40. In the present embodiment, the optical fibers 30 are inserted into the optical fiber introduction units 411 of the optical fiber guide 40 while sliding the optical ferule 61 of the optical fiber array 60 along the slide grooves 21. Therefore, the pair of slide grooves 21 formed on the motherboard 20 are formed facing the first short side 40B of the optical fiber guide 40.

Fitting recessed units 22 to which the cylindrical protrusions 62 provided at the four corners on the lower surface of the optical ferule 61 are fitted and locked are formed in the upper surface 20A of the motherboard 20. The fitting recessed units 22 are one-step deeper than a depth of the slide grooves 21. A planar positional relationship among the fitting recessed units 22 corresponds to a planar positional relationship among the protrusions 62 of the optical ferule 61. Therefore, the four protrusions 62 of the optical ferule 61 can be fitted into the four fitting recessed units 22 formed on the motherboard 20 at the same time. Here, a pair of fitting recessed units 22 are provided continuously to front end portions of the respective slide grooves 21. Also, a remaining pair of fitting recessed units 22 are provided in the upper surface 20A in a state slightly apart from and independent of rear end portions of the respective slide grooves 21.

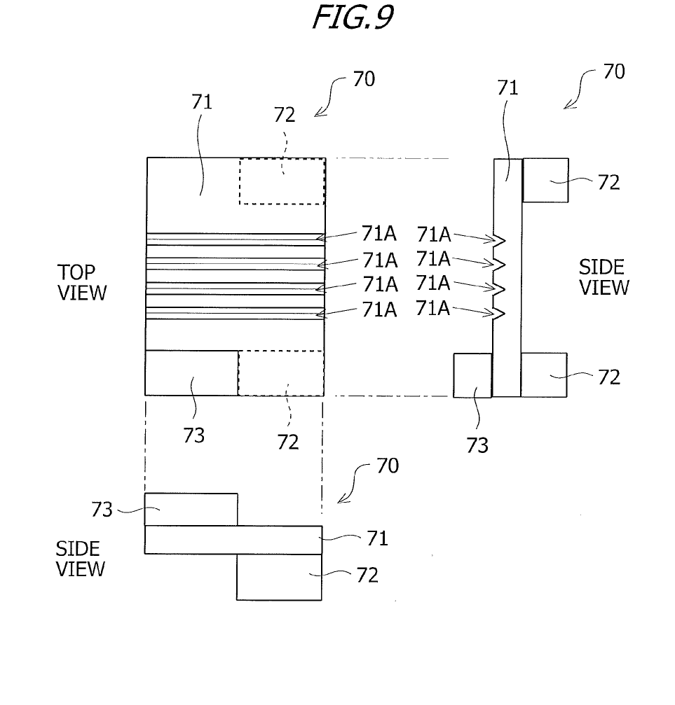

Subsequently, in the step illustrated in FIG. 8B, an optical fiber alignment jig 70 illustrated in FIG. 9 is installed on the optical module 10. FIG. 9 is a view illustrating the optical fiber alignment jig 70 according to the embodiment. The optical fiber alignment jig 70 is a member removably installed on the first short side 40B-side of the optical fiber guide 40 in the optical module 10 when the optical fiber array 60 (the optical fibers 30) is mounted (see FIG. 8B). The optical fiber alignment jig 70 has a body unit 71 having, in an upper surface, V-shaped guide grooves 71a that adjust lines of the optical fibers 30 of the optical fiber array 60, a pair of leg units 72 provided on a lower surface of the body unit 71, and a positioning unit 73 provided on the upper surface of the body unit 71.

The body unit 71 of the optical fiber alignment jig 70 has a flat plate shape, and the leg units 72 and the positioning unit 73 have a substantially rectangular parallelepiped shape. The pair of leg units 72 are provided in both side portions of the body unit 71, and support the body unit 71 in a horizontal position. In the optical fiber alignment jig 70, a height of the upper surface of the body unit 71 is substantially equal to a height of the guide mounting surface 12A of the optical waveguide substrate 12 in a state placed on the upper surface 20A of the motherboard 20. The body unit 71 of the optical fiber alignment jig 70 has a thickness substantially equal to that of the optical waveguide substrate 12. The number and a pitch of the plurality of V grooves 71a formed in the upper surface of the body unit 71 correspond to those of the optical fiber introduction units 411 of the optical fiber guide 40, and in the present embodiment, the four guide grooves 71a are arranged in parallel at an interval of 250 μm.

When the optical fiber alignment jig 70 is installed on the optical module 10, the body unit 71 is fitted into a gap between the package substrate 11 and the optical fiber guide 40 from a lateral side. The fitting of the body unit 71 into the above gap is performed in a state, for example, in which the upper surface of the body unit 71 is in sliding contact with a lower surface of the optical fiber guide 40, and the lower surface of the body unit 71 is in sliding contact with the upper surface of the package substrate 11. At this time, the positioning unit 73 of the optical fiber alignment jig 70 is brought into contact with the side surface of the optical fiber guide 40, and the pair of leg units 72 are brought into contact with an end surface of the package substrate 11, so that the optical fiber alignment jig 70 is positioned. As a result, the installment of the optical fiber alignment jig 70 is completed in a state in which the guide grooves 71a of the body unit 7 of the optical fiber alignment jig 70 and the optical fiber introduction units 411 of the optical fiber guide 40 vertically overlap, and face each other. Note that the optical fiber alignment jig 70 can be fabricated by, for example, glass machining.

In the present embodiment, the pair of protrusions 62 located on the front side of the optical ferule 61 are fitted into the pair of slide grooves 21 of the motherboard 20 in a state in which the optical fiber alignment jig 70 is installed on the optical module 10 as illustrated in FIG. 8B. In this state, the respective optical fibers 30 of the optical fiber array 60 are inserted to intermediate positions of the guide grooves 71a of the optical fiber alignment jig 70 and the optical fiber introduction units 411 of the optical fiber guide 40. By sliding the optical ferule 61 in a direction to approach the optical module 10 from this state, the protrusions 62 of the optical ferule 61 are fitted into the fitting recessed units 22 as illustrated in FIG. 8C. When the optical ferule 61 is slid in the direction to approach the optical module 10, the respective optical fibers 30 held in the optical ferule 61 are inserted toward distal end sides of the guide grooves 41 of the optical fiber guide 40.

By the way, the depth of the optical fiber introduction units 411 of the optical fiber guide 40 is larger than a diameter of the optical fibers 30. Therefore, clearances (gaps) are formed between the optical fiber introduction units 411 and the optical fibers 30 inserted into the optical fiber introduction units 411. Thus, the optical fibers 30 can be easily and smoothly inserted into the optical fiber introduction units 411. Moreover, since the guide grooves 71a in the optical fiber alignment jig 70 face the optical fiber introduction units 411, it becomes easier to insert the optical fibers 30.

When the distal-end inclined surfaces 31 of the optical fibers 30 reach the optical fiber adjustment units 412, the positions of the optical fibers 30 are adjusted in the widthwise direction in the optical fiber adjustment units 412. Here, since the width of the optical fiber adjustment units 412 is substantially equal to the diameter of the optical fibers 30, an interval between the optical fibers 30 can be adjusted when the optical fibers 30 pass through the optical fiber adjustment units 412. In the present embodiment, in the optical fiber adjustment units 412, the positions of the optical fibers 30 are adjusted such that the interval between the respective optical fibers 30 matches an interval between the optical waveguides 123 in the optical waveguide substrate 12. Note that the depth of the optical fiber adjustment units 412 is larger than the diameter of the optical fibers 30, so that the optical fibers 30 can be smoothly inserted through the optical fiber adjustment units 412.

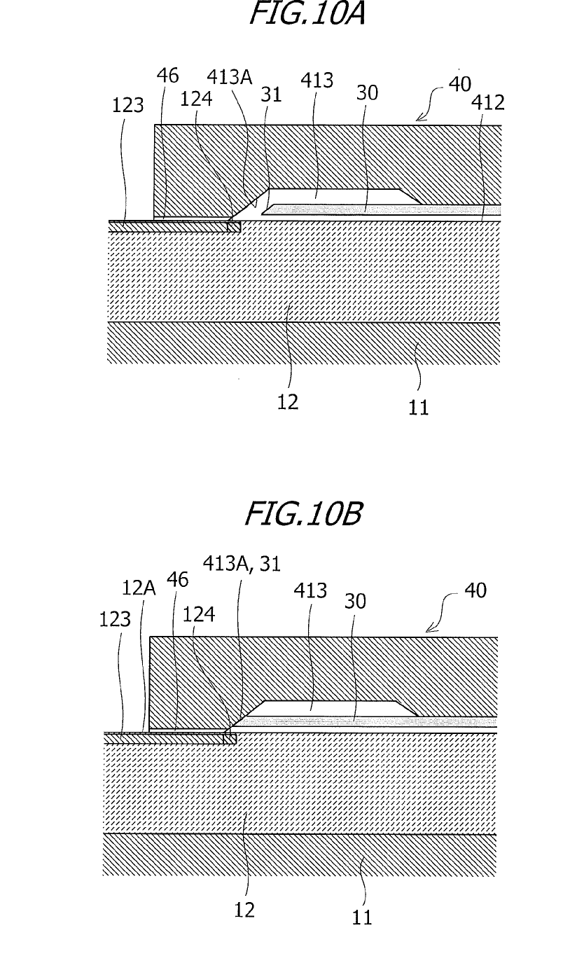

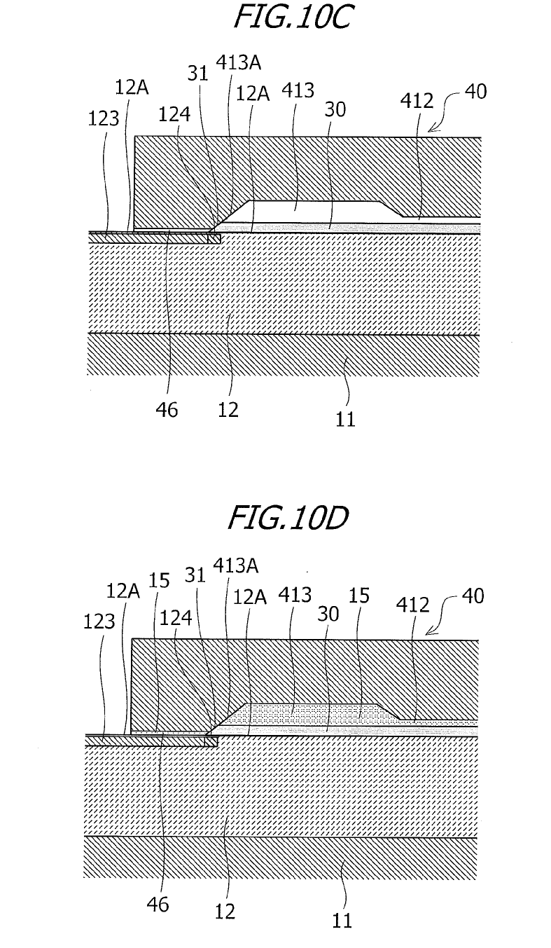

FIGS. 10A to 10D are views for explaining a positioning mechanism for the optical fiber 30 in the optical fiber guide 40. Each of the optical fibers 30, the line of which is adjusted in the optical fiber adjustment unit 412 is inserted into the optical fiber positioning unit 413, and advances through the optical fiber positioning unit 413 toward the slide inclined surface 413A formed on the distal end side (FIG. 10A). When the distal-end inclined surface 31 of the optical fiber 30 comes into contact with the slide inclined surface 413A of the optical fiber positioning unit 413 as illustrated in FIG. 10B, the distal-end inclined surface 31 slides downward along the slide inclined surface 413A since the groove depth of the optical fiber positioning unit 413 is larger than the diameter of the optical fiber 30. That is, the distal-end inclined surface 31 of the optical fiber 30 slides on a surface of the slide inclined surface 413A toward the optical waveguide substrate 12, and as a result, the distal end side of the optical fiber 30 slides to an obliquely downward front side.

When a lower end portion of the distal-end inclined surface 31 comes into contact with the guide mounting surface 12A of the optical waveguide substrate 12 as illustrated in FIG. 10C, the sliding action of the distal-end inclined surface 31 on the slide inclined surface 413A is terminated, and the optical fiber 30 is positioned. In the present embodiment, it is adjusted such that the distal end of the optical fiber 30 and a plane surface position of the optical coupling unit 124 match each other when the distal-end inclined surface 31 slides along the slide inclined surface 413A, and the lower end portion of the distal-end inclined surface 31 comes into contact with the optical coupling unit 124 of the optical waveguide substrate 12. Accordingly, the alignment of the optical fiber 30 is easily and accurately performed, and highly-efficient optical coupling between the optical fiber 30 and the optical coupling unit 124 is achieved.

Note that the distal-end inclined surface 31 of the optical fiber 30 also functions as a mirror that reflects light. Light emitted from the distal-end inclined surface 31 of the optical fiber 30 is reflected at the slide inclined surface 413A of the optical fiber guide 40, and enters the optical waveguide 123 from the optical coupling unit 124 to propagate through the optical waveguide 123. Also, light emitted from the optical coupling unit 124 of the optical waveguide 123 is reflected at the slide inclined surface 413A of the optical fiber guide 40, and enters a core of the optical fiber 30 from the distal-end inclined surface 31 to propagate through the core.

By the way, as illustrated in FIG. 8C, in a state in which the respective protrusions 62 of the optical ferule 61 are fitted into the fitting recessed units 22 of the motherboard 20, a section (referred to as a “free-end section” below. See FIG. 7) on the distal end side of the optical fiber 30 with respect to the optical ferule 61 is buckled (curved). In the present embodiment, a length of the free-end section of the optical fiber 30 is adjusted such that the distal-end inclined surface 31 comes into contact with the slide inclined surface 413A before the respective protrusions 62 of the optical ferule 61 are fitted into the fitting recessed units 22, that is, during the sliding action of the optical ferule 61.

Accordingly, by further sliding the optical ferule 61 after the distal-end inclined surface 31 of each of the optical fibers 30 comes into contact with the slide inclined surface 413A of the optical fiber guide 40, the distal-end inclined surface 31 can be slid along the slide inclined surface 413A as described above. After the optical fiber 30 is positioned with the lower end portion of the distal-end inclined surface 31 contacting with the optical coupling unit 124 of the optical waveguide substrate 12, an excess length of the free-end section of the optical fiber 30 can be buckled. Accordingly, there is an advantage that, even if there is a slight variation in the lengths of the free-end sections of the optical fibers 30, the variation in the lengths can be absorbed by changing buckling amounts of the free-end sections. Therefore, even if there is a variation in the lengths of the plurality of optical fibers 30 included in the optical fiber array 60, the above variation can be absorbed by buckling the free-end sections, and all the optical fibers 30 can be accurately and easily aligned. Note that the buckling amount of the free-end section at the time of mounting the optical fiber 30 is increased as the free-end section of the optical fiber 30 is larger.

After the positioning of the optical fiber 30 is performed as described above, the adhesive 15 is introduced (injected) from the adhesive introduction groove 46 that opens on the second short side 40C-side of the optical fiber guide 40 as illustrated in FIG. 10D. The adhesive 15 can be introduced by using, for example, a capillary phenomenon. The adhesive 15 is supplied to the optical fiber positioning unit 413 through the adhesive introduction groove 46, and the optical fiber 30 is fixed in an aligned state. As a specific example, an optical adhesive (manufactured by Epoxy Technology, Inc., model name: EPOTEK314) may be introduced from the adhesive introduction groove 46 by a capillary phenomenon. Note that the adhesive 15 is supplied to an intermediate position of the optical fiber adjustment unit 412 such that the optical fiber positioning unit 413 is filled with the adhesive 15 in an example illustrated in FIG. 10D. A gap between the groove formation surface 40A of the optical fiber guide 40 and the guide mounting surface 12A of the optical waveguide substrate 12 is also filled with the adhesive 15. Also, in the present embodiment, the adhesive 15 introduced from the adhesive introduction groove 46 is cured by spot-heating the optical fiber guide 40 at about 150° C. Accordingly, a solder-joined portion of the optical fiber guide 40 to which the optical fibers 30 are positioned and fixed and which is flip-chip mounted on the optical waveguide substrate 12 can be expected to be protected, and reinforced and cured.

The optical fiber alignment jig 70 in the present embodiment is removably attached to the optical module 10. For example, by removing the optical fiber alignment jig 70 from the optical module 10 after positioning the optical fibers 30 in the optical fiber array 60, the optical fiber alignment jig 70 can be re-used.

The mounting of the optical fibers 30 according to the present embodiment is completed by fixing the optical ferule 61 of the optical fiber array 60 to the motherboard 20 as illustrated in FIG. 8D. As a specific example, the adhesive 15 may be introduced into a gap between the upper surface 20A of the motherboard 20 and the optical ferule 61 by using a capillary phenomenon, and left at a normal temperature (for example, for about 24 hours) to be cured. The adhesive may be also cured by spot-heating, and a curing method is not particularly limited.

As described above, in accordance with the optical fiber guide 40 according to the present embodiment, the optical fibers 30 can be easily and accurately aligned with the optical waveguide substrate 12. That is, a technique for enabling easy and accurate alignment of the optical fibers 30 with the optical waveguide substrate 12 can be provided.

Furthermore, in accordance with the optical fiber guide 40 according to the present embodiment, the inclination angle of the slide inclined surface 413A with respect to the axial direction of the optical fiber positioning unit 413 corresponds to the inclination angle of the distal-end inclined surface 31 with respect to the optical axis of the optical fiber 30. Accordingly, when the distal-end inclined surface 31 of the optical fiber 30 contacts with the slide inclined surface 413A of the optical fiber guide 40, the both surfaces more surely come into surface contact with each other. As a result, there is an advantage that the distal-end inclined surface 31 of the optical fiber 30 can be more smoothly slid along the surface of the slide inclined surface 413A of the optical fiber guide 40.

Next, positioning accuracy when the optical fibers 30 are mounted by using the optical fiber guide 40 according to the present embodiment is described. Here, as a cause of mounting displacement of the optical fiber 30, two causes, i.e., displacement in mounting the optical fiber guide 40 and horizontal inclination of the optical fiber 30 are considered. Here, mounting accuracy of the flip chip bonder that mounts the optical fiber guide 40 on the optical waveguide substrate 12 roughly falls within ±0.5 μm. Also, a displacement amount caused by angular deviation in the horizontal direction of the optical fiber 30 generated in the optical fiber adjustment unit 412 of the optical fiber guide 40 roughly falls within ±0.5 μm. Therefore, a total displacement amount of the optical fiber 30 falls within about 0.7 μm calculated as the square root of sum of squares thereof. Also, when 20 samples where the optical fibers 30 are mounted on the optical waveguide substrate 12 by using the aforementioned optical fiber guide 40 are fabricated, a result is obtained in which an optical coupling failure due to displacement of the distal ends of the optical fibers 30 does not occur, and an assembly yield is 100%.

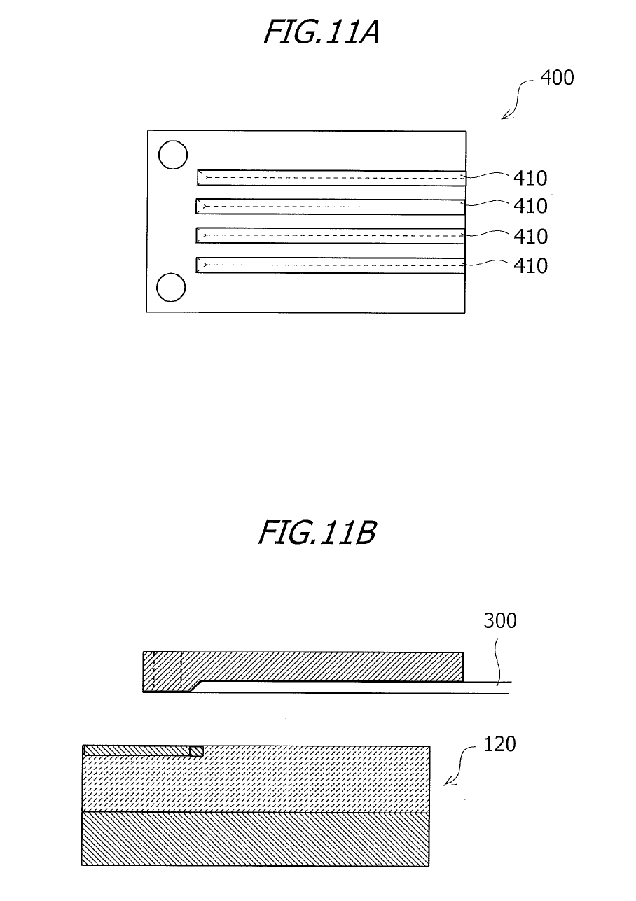

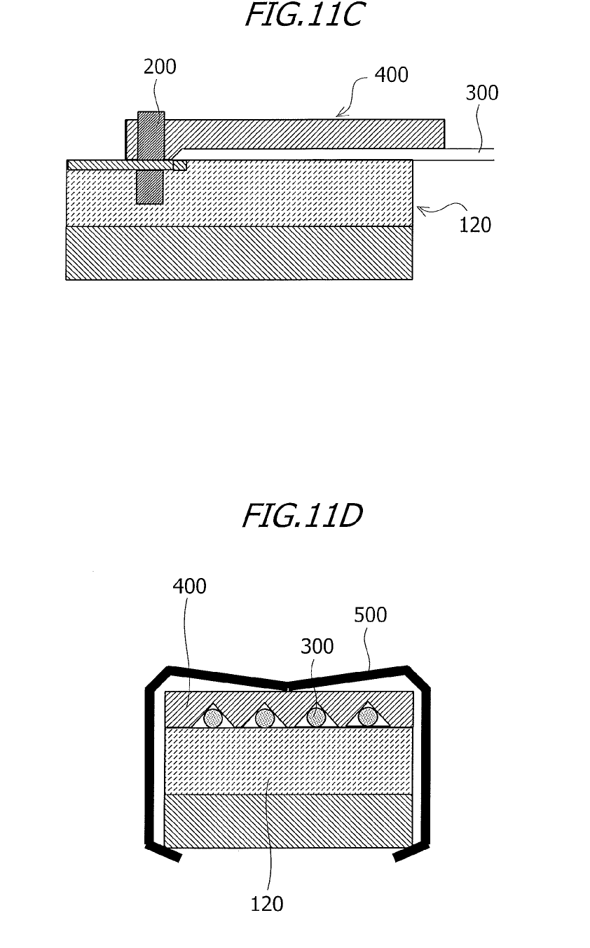

Next, accuracy when an optical fiber connector 400 according to a comparative example as illustrated in FIGS. 11A to 11D is fabricated, and optical fibers 300 are mounted by using the optical fiber connector 400 is described. FIG. 11A is a plan view of the optical fiber connector 400 according to the comparative example as viewed from a groove formation surface. The optical fiber connector 400 is a grooved substrate in which accommodation grooves 410 capable of tightly accommodating the optical fibers 300 with little clearance formed between the accommodation grooves 410 and the accommodation grooves 410 are formed in a number corresponding to that of the optical fibers 300.

In the comparative example, an optical waveguide substrate 120 illustrated in FIG. 11B is prepared. While distal ends of the optical fibers 300 are being manually adjusted so as to be fitted to distal ends of the accommodation grooves 410 of the optical fiber connector 400, the optical fiber connector 400 and the optical waveguide substrate 120 are connected by a connection pin 200 as illustrated in FIG. 11C. After that, as illustrated in FIG. 11D, the optical fiber connector 400 and the optical waveguide substrate 120 are fixed by using a metal clamp 500 having elasticity, so that the mounting of the optical fibers 300 according to the comparative example is completed. When 20 samples where the optical fibers 300 are mounted on the optical waveguide substrate 120 by using the optical fiber connector 400 according to the comparative example are fabricated, an optical coupling failure is occurred due to displacement of the distal ends of the optical fibers 300 in 5 samples. A result is obtained in which an assembly yield according to the comparative example is 80%, and the samples in which the optical coupling failure occurred are re-assembled.

It is obvious for a person skilled in the art that various changes and modifications can be made in the above embodiment. For example, although the example in which the optical fiber guide 40 is fabricated by an etching process on the Si substrate has been described in the above embodiment, a type or a processing method of the substrate used for the optical fiber guide 40 is not particularly limited. For example, a metal substrate or a resin substrate may be used instead of the Si substrate, and a pressing process, an imprinting process, and an injection molding process etc. may be appropriately employed instead of the etching process. Also, although the optical fiber guide 40 is flip-chip mounted on the optical waveguide substrate 12 in the present embodiment, the present embodiment is not limited thereto. For example, the optical fiber guide 40 may be bonded to the optical waveguide substrate 12 by using an adhesive.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. An optical fiber guide that guides an optical fiber, the optical fiber guide comprising:
a first substrate; and
a guide groove that is formed on a main surface of the first substrate, the optical fiber being insertable from one end side of the guide groove,
wherein the guide groove includes a positioning unit that forms a distal end portion of the guide groove, the positioning unit having a slide inclined surface that positions the optical fiber by sliding a distal-end inclined surface of the optical fiber in contact therewith.

2. The optical fiber guide according to claim 1,
wherein the first substrate is fixed on an optical waveguide substrate so that the main surface faces the optical waveguide substrate, and
the slide inclined surface of the positioning unit slides the distal-end inclined surface in contact therewith toward the optical waveguide substrate.

3. The optical fiber guide according to claim 1,
wherein the guide groove further includes an adjustment groove unit that is formed on a proximal end side of the positioning unit and adjusts a position of the optical fiber with respect to the first substrate.

4. The optical fiber guide according to claim 1, further comprising an adhesive introduction groove that is formed on the main surface of the first substrate and introduces an adhesive into the guide groove.

5. The optical fiber guide according to claim 4,
wherein the adhesive introduction groove connects with the positioning unit of the guide groove.

6. The optical fiber guide according to claim 1,
wherein an inclination angle of the slide inclined surface with respect to an axial direction of the positioning unit is equal to an inclination angle of the distal-end inclined surface with respect to an optical axis of the optical fiber.

7. The optical fiber guide according to claim 1,
wherein a groove depth of the positioning unit is larger than a diameter of the optical fiber.

8. The optical fiber guide according to claim 1,
wherein the plurality of guide grooves are arranged on the main surface of the first substrate.

9. The optical fiber guide according to claim 1,
wherein at least one or more connection pads are provided on the main surface of the first substrate.

10. The optical fiber guide according to claim 1,
wherein the slide inclined surface is formed by anisotropic etching of silicon.

11. An optical waveguide substrate comprising an optical fiber guide that guides an optical fiber,
the optical fiber guide comprising:
a first substrate is fixed on the optical waveguide substrate so that a main surface of the first substrate faces the optical waveguide substrate; and
a guide groove that is formed on the main surface of the first substrate, the optical fiber being insertable from one end side of the guide groove,
wherein the guide groove includes a positioning unit that forms a distal end portion of the guide groove, the positioning unit having a slide inclined surface that positions the optical fiber by sliding a distal-end inclined surface of the optical fiber in contact therewith toward the optical waveguide substrate.

12. The optical waveguide substrate comprising the optical fiber guide according to claim 11,
wherein the optical fiber guide is mounted on the optical waveguide substrate by solder joining.

13. An optical input-output device comprising:
an optical waveguide substrate;
an optical fiber that is mounted on the optical waveguide substrate; and
an optical fiber guide that is provided on the optical waveguide substrate, and guides the optical fiber, the optical fiber guide including
a first substrate including a main surface facing the optical waveguide substrate, and
a guide groove that is formed on the main surface of the first substrate, the optical fiber being insertable from one end side of the guide groove,
wherein the guide groove includes a positioning unit that forms a distal end portion of the guide groove, the positioning unit having a slide inclined surface that positions the optical fiber by sliding a distal-end inclined surface of the optical fiber in abutment therewith toward the optical waveguide substrate, and
the optical fiber is positioned in a state in which the distal-end inclined surface is in contact with the slide inclined surface.

14. A method of mounting an optical fiber to an optical waveguide substrate comprising an optical fiber guide that guides the optical fiber,
the optical fiber guide comprising:
a first substrate that is fixed with a main surface facing the optical waveguide substrate; and
a guide groove that is formed on the main surface of the first substrate, the optical fiber being insertable from one end side of the guide groove,
the method comprising: inserting the optical fiber from one end side of the guide groove, bringing a distal-end inclined surface of the optical fiber into contact with a slide inclined surface of a positioning unit that forms a distal end portion of the guide groove; and sliding the distal-end inclined surface toward the optical waveguide substrate to position the optical fiber.
